(19) United States
(12) Patent Application Publication
(10) Pub. No.: US 2024/0087176 A1
(43) Pub. Date: Mar. 14, 2024

(54) POINT CLOUD DECODING METHOD AND APPARATUS, POINT CLOUD ENCODING METHOD AND APPARATUS, COMPUTER DEVICE, COMPUTER-READABLE STORAGE MEDIUM

(71) Applicant: Tencent Technology (Shenzhen) Company Limited, Shenzhen (CN)

(72) Inventors: Wenjie ZHU, Shenzhen (CN); Shan LIU, San Jose, CA (US)

(73) Assignee: Tencent Technology (Shenzhen) Company Limited, Shenzhen (CN)

(21) Appl. No.: 18/514,586

(22) Filed: Nov. 20, 2023

Related U.S. Application Data
(63) Continuation of application No. PCT/CN2022/123771, filed on Oct. 8, 2022.

(30) Foreign Application Priority Data
Dec. 6, 2021 (CN) 202111482241.0

(51) Int. Cl. G06T 9/40

(52) U.S. Cl. CPC G06T 9/40

(57) ABSTRACT

A point cloud decoding method is provided. In the method, a target point cloud group of a plurality of point cloud groups is obtained. The target point cloud group includes at least one point. An attribute coding mode of the target point cloud group is determined. Prediction attribute information of each point in the target point cloud group is obtained based on attribute prediction of the respective point in the target point cloud group according to the attribute coding mode of the target point cloud group. Reconstruction residual information of each point in the target point cloud group is obtained based on attribute decoding of the respective point in the target point cloud group. Reconstruction attribute information of each point in the target point cloud group is determined according to the prediction attribute information and the reconstruction residual information of the respective point in the target point cloud group.

### RELATED APPLICATIONS

This application is a continuation of International Application No. PCT/CN2022/123771, filed on Oct. 8, 2022, which claims priority to Chinese Patent Application No. 202111482241.0, filed on Dec. 6, 2021. The entire disclosures of the prior applications are hereby incorporated by reference.

### FIELD OF THE TECHNOLOGY

This disclosure relates to the field of computer technologies, including to a point cloud decoding method and apparatus, a point cloud encoding method and apparatus, a computer device, a computer-readable storage medium, and a computer program product.

### BACKGROUND OF THE DISCLOSURE

With continuous development of science and technology, currently, a large quantity of high-precision point cloud data can be obtained with a relatively low cost and in a relatively short time period. The point cloud data may include multiple points, and each point has geometric information and attribute information. To improve transmission efficiency of the point cloud data, before the point cloud data is transmitted, the point cloud data may be encoded and processed to reduce a data volume, thereby reducing bandwidth occupied for data transmission. That is, after encoding the point cloud data, an encoder may transmit the encoded point cloud data to a decoder, and the decoder may decode the encoded point cloud data to reconstruct the point cloud data. A quantity of attribute information of each point in the point cloud data can be relatively large, and a large quantity of attribute information causes pressure in an encoding and decoding process. Therefore, encoding and decoding efficiency of a point cloud attribute (that is, attribute information in the point cloud data) is not high.

### SUMMARY

Embodiments of this disclosure include a point cloud decoding method and apparatus, a point cloud encoding method and apparatus, a computer device, a non-transitory computer-readable storage medium, and a computer program product, so as to improve encoding and decoding efficiency of a point cloud attribute.

An embodiment of this disclosure provides a point cloud decoding method. In the method, a target point cloud group of a plurality of point cloud groups is obtained. The target point cloud group includes at least one point. An attribute coding mode of the target point cloud group is determined. Prediction attribute information of each point in the target point cloud group is obtained based on attribute prediction of the respective point in the target point cloud group according to the attribute coding mode of the target point cloud group. Reconstruction residual information of each point in the target point cloud group is obtained based on attribute decoding of the respective point in the target point cloud group. Reconstruction attribute information of each point in the target point cloud group is determined according to the prediction attribute information and the reconstruction residual information of the respective point in the target point cloud group.

An embodiment of this disclosure provides a point cloud encoding method. In the method, a target point cloud group of a plurality of point cloud groups is obtained. The target point cloud group includes at least one point. An attribute coding mode of the target point cloud group is determined. Prediction attribute information of each point in the target point cloud group is obtained based on attribute prediction of the respective point in the target point cloud group according to the attribute coding mode of the target point cloud group. Prediction residual information of each point in the target point cloud group is determined according to the prediction attribute information and real attribute information of the respective point in the target point cloud group. Attribute encoding is performed on each point in the target point cloud group based on the prediction residual information of the respective point in the target point cloud group, to obtain an encoded target point cloud group.

An embodiment of this disclosure provides a point cloud decoding apparatus, including processing circuitry. The processing circuitry is configured to obtain a target point cloud group of a plurality of point cloud groups. The target point cloud group includes at least one point. The processing circuitry is configured to determine an attribute coding mode of the target point cloud group. The processing circuitry is configured to obtain prediction attribute information of each point in the target point cloud group based on attribute prediction of the respective point in the target point cloud group according to the attribute coding mode of the target point cloud group. The processing circuitry is configured to obtain reconstruction residual information of each point in the target point cloud group based on attribute decoding of the respective point in the target point cloud group. Further, the processing circuitry is configured to determine reconstruction attribute information of each point in the target point cloud group according to the prediction attribute information and the reconstruction residual information of the respective point in the target point cloud group.

An embodiment of this disclosure provides a point cloud encoding apparatus, including processing circuitry. The processing circuitry is configured to obtain a target point cloud group. The target point cloud group includes at least one point. The processing circuitry is configured to determine an attribute coding mode of the target point cloud group. The processing circuitry is configured to obtain prediction attribute information of each point in the target point cloud group based on attribute prediction of the respective point in the target point cloud group according to the attribute coding mode of the target point cloud group. The processing circuitry is configured to determine prediction residual information of each point in the target point cloud group according to the prediction attribute information and real attribute information of the respective point in the target point cloud group. The processing circuitry is configured to perform attribute encoding on each point in the target point cloud group based on the prediction residual information of the respective point in the target point cloud group, to obtain an encoded target point cloud group.

An embodiment of this disclosure provides a computer device, where the computer device includes a processor and a computer-readable storage medium. The processor is adapted to implement a computer program; and the computer-readable storage medium stores a computer program, and the computer program is adapted to be loaded the processor to perform the foregoing point cloud decoding method and point cloud encoding method.

An embodiment of this disclosure provides a non-transitory computer-readable storage medium. The computer-readable storage medium stores instructions which when executed by a processor cause the processor to perform at least one of the foregoing point cloud decoding method or point cloud encoding method.

An embodiment of this disclosure provides a computer program product or a computer program. The computer program product or the computer program includes computer instructions, and the computer instructions are stored in a computer-readable storage medium. A processor of a computer device reads the computer instruction from the computer-readable storage medium, and the processor executes the computer instruction, so that the computer device performs the foregoing point cloud decoding method and point cloud encoding method.

### BRIEF DESCRIPTION OF THE DRAWINGS

To describe technical solutions in embodiments of this disclosure more clearly, the following briefly introduces the accompanying drawings required for describing the embodiments. The accompanying drawings in the following description show only some embodiments of this disclosure. Other embodiments are within the scope of the present disclosure.

FIG. 1 is a schematic diagram of an encoding framework according to an embodiment of this disclosure.

FIG. 2 is a schematic architecture diagram of a point cloud attribute encoding and decoding system according to an embodiment of this disclosure.

FIG. 3 is a schematic flowchart of a point cloud decoding method according to an embodiment of this disclosure.

FIG. 4a is a schematic diagram of a point cloud data grouping manner according to an embodiment of this disclosure.

FIG. 4b is a schematic diagram of a point cloud data grouping manner according to an embodiment of this disclosure.

FIG. 4c is a schematic diagram of a point cloud data grouping manner according to an embodiment of this disclosure.

FIG. 5 is a schematic flowchart of a point cloud decoding method according to an embodiment of this disclosure,

FIG. 6 is a schematic diagram of a neighboring point determining process according to an embodiment of this disclosure.

FIG. 7 is a schematic flowchart of a point cloud encoding method according to an embodiment of this disclosure.

FIG. 8 is a schematic structural diagram of a point cloud decoding apparatus according to an embodiment of this disclosure.

FIG. 9 is a schematic structural diagram of a point cloud encoding apparatus according to an embodiment of this disclosure.

FIG. 10 is a schematic structural diagram of a computer device according to an embodiment of this disclosure.

### DESCRIPTION OF EMBODIMENTS

The technical solutions in embodiments of this disclosure are described in the following with reference to the accompanying drawings. The described embodiments are some rather than all of the embodiments of this disclosure. Other embodiments o shall fall within the scope of this disclosure.

To better understand the technical solutions provided in the embodiments of this disclosure, exemplary terms in the embodiments of this disclosure are first described herein.

(1) Point cloud data. The point cloud data may be a discrete point set in space that is randomly distributed and that represents a spatial structure and a surface attribute of a three-dimensional object or a three-dimensional scene. The point cloud data may include multiple points, and each point has geometric information and attribute information. The geometric information may also be referred to as three-dimensional position information. Geometric information of any point may be referred to as three-dimensional coordinates (x, y, z) of the point, and may include coordinates of the point on each coordinate axis of the three-dimensional coordinate system, that is, coordinate x of an X axis, coordinate y of a Y axis, and coordinate z of a Z axis. The attribute information of any point may include at least one of the following: color information, material information, and laser reflection intensity information (which may also be referred to as reflectivity). Each point in the point cloud data may have the same quantity of attribute information. For example, each point in the point cloud data may have two types of attribute information: color information and laser reflection intensity. Alternatively, each point in the point cloud data may have three types of attribute information: color information, material information, and laser reflection intensity information. In addition, point cloud data may be classified into different categories according to different classification standards. For example, the point cloud data may be classified into dense point cloud and sparse point cloud according to a manner of obtaining the point cloud data. For another example, the point cloud data may be classified into a static point cloud and a dynamic point cloud according to a time sequence type of the point cloud data.

(2) Point cloud encoding (Point Cloud Compression, PCC). Point cloud encoding is a process of encoding point cloud data to obtain a compressed code stream of the point cloud data. Point cloud encoding may include two main processes: geometric information encoding and attribute information encoding. Currently, mainstream point cloud encoding technologies may be classified into point cloud encoding based on a geometric structure and point cloud encoding based on a projection for different types of point cloud data. Herein, geometry-based point cloud compression (G-PCC) in the Moving Picture Expert Group (MPEG) and a point cloud encoding standard AVS-PCC in an Audio Video Coding Standard (AVS) are used as examples for description.

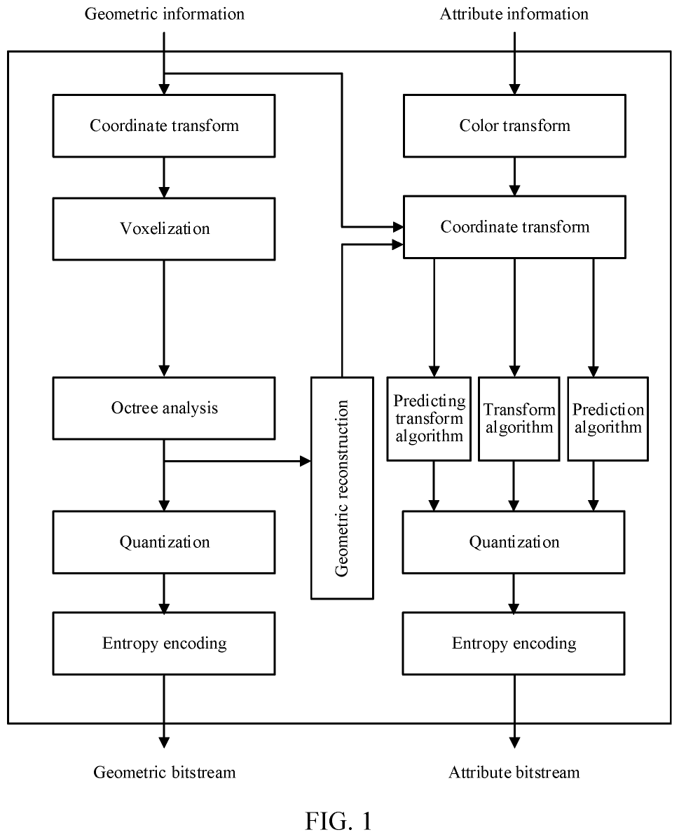

Encoding frameworks of G-PCC and AVS-PCC are approximately the same. As shown in FIG. 1, the encoding framework may be divided into a geometric information encoding process and an attribute information encoding process. The geometric information encoding process is to encode geometric information of each point in point cloud data to obtain a geometric bitstream. The attribute information encoding process is to encode attribute information of each point in point cloud data to obtain an attribute bitstream. The geometric bitstream and the attribute bitstream together form a compressed code stream of the point cloud data.

For main operations and processing in the geometric information encoding process, reference may be made to the following description:

(a) Pre-processing: It may include Transform Coordinates and Voxelize, where Voxelize is a process of simulating geometric information of each point in point cloud data by using a uniform-size voxel grid. By scaling and translating, point cloud data in three-dimensional space is converted into an integer form and its minimum geometric position is moved to a coordinate origin.

(b) Geometric octree encoding (Octree): For example, in the octree analysis of FIG. 1, the octree is a tree data structure. In three-dimensional space division, a preset bounding box is evenly divided, and each node has eight sub-nodes. Occupation code information is obtained as a code stream of point cloud geometric information by using “1” and “0” to indicate occupation of each sub-node of the octree. The bounding box is an algorithm for solving optimal bounding space of a discrete point set, and a basic idea is to approximately replace a complex geometric object with a geometric body (referred to as a bounding box) that is slightly larger in size and has simple characteristics.

(c) Geometric predictive tree encoding (Predictive Tree): It is to, for example, analyze a proximity relationship between three-dimensional coordinates of each point in the point cloud data, set a specific criterion to connect each point one by one to a single-chain or multi-chain tree structure, calculate a residual value by using coordinates between a parent node and a child node that are connected head to tail, and encode the residual value and a possible index value and a calculation method.

(d) Geometric encoding based on triangular representation (Trisoup): In an example, on the basis of point cloud block division, an intersection point of a point cloud surface on an edge of a block is located, and a triangle is constructed. Geometric information is compressed by encoding the intersection point location. The point cloud block is obtained by dividing three-dimensional space in which each point in the point cloud data is located, and each point cloud block includes some points in the point cloud data.

(e) Geometry quantization: Degree of precision of quantization is usually determined by a quantizer parameter (QP). When a value of the QP is greater than a QP threshold, a coefficient indicating a larger value range is quantized to the same output, and therefore, larger distortion and a lower bit rate are usually brought. In contrast, when the value of the QP is less than the QP threshold, a coefficient indicating a relatively small value range is quantized to the same output, and therefore, relatively small distortion is usually caused, and the bit rate is relatively high. In point cloud encoding, a quantization objective is coordinate information of each point in the point cloud data.

(f) Geometry entropy encoding: Statistical compression encoding can be performed on occupation code information of the octree, and finally a binary (0 or 1) compressed code stream is outputted. Statistical encoding is a lossless encoding method, which can effectively reduce the bit rate required to express the same signal. A common statistical encoding manner is Content Adaptive Binary Arithmetic Coding (CABAC).

For main operations and processing in the attribute information encoding process, reference can be made to the following description:

(a) Attribute recoloring: It is color transform in FIG. 1. In a case of lossy encoding, after geometric information encoding, a decoder side needs to decode and reconstruct geometric information, that is, restore geometric information of each point in the point cloud data. Original point cloud data is searched for attribute information corresponding to one or more neighboring points as attribute information of the reconstruction point.

(b) Attribute prediction encoding (Prediction): It is a prediction algorithm in FIG. 1. It is to select attribute information of one or more points by using a proximity relationship between geometric information or attribute information, obtain final prediction attribute information by means of weighted averaging, and encode prediction residual information between real attribute information and prediction attribute information.

(c) Attribute transform encoding (Transform): It is a transform algorithm in FIG. 1. It is to analyze a proximity relationship of geometric information, converts, by using a transform matrix, real attribute information corresponding to a specific quantity of points into a transform coefficient, and encode the transform coefficient.

(d) Attribute predicting transform encoding (Predicting transform): It is a predicting transform algorithm in FIG. 1. Based on prediction residual information obtained by means of prediction, prediction residual information corresponding to a specific quantity of points is converted into a transform coefficient by using a transform matrix, and the transform coefficient is encoded.

(e) Attribute information quantization (Attribute Quantization): A degree of fineness of quantization is usually determined by a quantizer parameter. In attribute prediction encoding, entropy encoding is performed on quantized prediction residual information. In attribute transform encoding and attribute predicting transform encoding, entropy encoding is performed on a quantized transform coefficient.

(f) Attribute entropy encoding: The quantized prediction residual information or transform coefficient generally uses run length coding and the arithmetic coding to implement final compression. Information such as a corresponding encoding mode and a quantizer parameter is also encoded by using an entropy encoder.

(3) Point cloud decoding. Point cloud decoding is a process of decoding a compressed code stream of point cloud data to reconstruct point cloud data. In an example, it may be a process of reconstructing geometric information and attribute information of each point in the point cloud data based on a geometric bitstream and an attribute bitstream in a compressed code stream. After a decoder obtains the compressed code stream of the point cloud data, for the geometric bitstream, entropy decoding is first performed to obtain quantized geometric information of each point in the point cloud data, and then dequantization is performed to reconstruct the geometric information of each point in the point cloud data. For the attribute bitstream, entropy decoding is first performed to obtain quantized prediction residual information or a quantized transform coefficient of each point in the point cloud data. Then, dequantization is performed on the quantized prediction residual information to obtain reconstruction residual information, dequantization is performed on the quantized transform coefficient to obtain a reconstruction transform coefficient, reconstruction residual information is obtained after inverse transform of the reconstruction transform coefficient, and the attribute information of each point in the point cloud data can be reconstructed according to the reconstruction residual information of each point in the point cloud data. The reconstructed attribute information of each point in the point cloud data is sequentially corresponding to the reconstructed geometric information in a one to one correspondence to obtain the reconstructed point cloud data.

Based on the foregoing related descriptions of point cloud data, point cloud encoding, and point cloud decoding, the embodiments of this disclosure provide a point cloud attribute decoding solution and a point cloud attribute encoding solution that use a point cloud group as an attribute prediction unit. In the point cloud attribute decoding solution, to-be-decoded point cloud data may include multiple to-be-decoded points, and the to-be-decoded point cloud data may be divided into multiple point cloud groups. For any to-be-decoded point cloud group, an attribute decoding mode of the point cloud group may be obtained, attribute prediction is performed on the point cloud group according to an attribute decoding mode of the point cloud group to obtain prediction attribute information of each point in the point cloud group, and attribute decoding processing is performed on each point in the target point cloud group to obtain reconstruction residual information of each point in the target point cloud group, and reconstruction attribute information of each point in the target point cloud group is determined according to the prediction attribute information and the reconstruction residual information of each point in the target point cloud group. In the point cloud attribute decoding solution in which a point cloud group is used as an attribute prediction unit, an obtained attribute decoding mode of the point cloud group may be applicable to attribute prediction on each point in the point cloud group. In this way, attribute prediction efficiency of each point in the point cloud group can be improved, and decoding efficiency of the point cloud attribute can be further improved. Similarly, in the point cloud attribute encoding solution, to-be-encoded point cloud data may include multiple to-be-encoded points, and the to-be-encoded point cloud data may be divided into multiple point cloud groups. For any to-be-encoded point cloud group, an attribute encoding mode of the point cloud group may be obtained, and attribute prediction is performed on the point cloud group according to an attribute encoding mode of the point cloud group to obtain prediction attribute information of each point in the point cloud group. Then, prediction residual information of each point in the target point cloud group may be determined according to the prediction attribute information and real attribute information of each point in the target point cloud group, and encoding processing is performed on each point in the target point cloud group based on the prediction residual information of each point in the target point cloud group to obtain an encoded target point cloud group. In the point cloud attribute encoding solution in which a point cloud group is used as an attribute prediction unit, an obtained attribute encoding mode of the point cloud group may be applicable to attribute prediction on each point in the point cloud group. In this way, attribute prediction efficiency of each point in the point cloud group can be improved, and encoding efficiency of the point cloud attribute can be further improved.

Based on the foregoing description, the following describes a point cloud attribute encoding and decoding system that is applicable to implementing the point cloud attribute decoding solution and the point cloud attribute encoding solution provided in the embodiments of this disclosure. As shown in FIG. 2, a point cloud attribute encoding and decoding system 20 may include an encoding device 201 and a decoding device 202. The encoding device 201 or the decoding device 202 may be a terminal device, or may be a server. A communication connection may be established between the encoding device 201 and the decoding device 202. The terminal device may be a smartphone, a tablet computer, a notebook computer, a desktop computer, a smart sound box, a smart watch, an in-vehicle terminal, an intelligent television, or the like, but is not limited thereto. The server may be an independent physical server, or may be a server cluster or a distributed system formed by multiple physical servers, or may be a cloud server that provides basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform.

In some embodiments, the point cloud encoding method and the point cloud decoding method provided in this embodiment of this disclosure may be applied to multiple scenarios such as mapping, transportation, electricity, forestry, and geology. Using a ground mapping scenario as an example, after the encoding device collects a to-be-measured region by using a capture device (for example, a laser device) to obtain point cloud data, the encoding device may encode the collected point cloud data by using the point cloud encoding method provided in this embodiment of this disclosure, and then send an encoded compressed code stream to the decoding device, so that the decoding device decodes it according to the point cloud decoding method provided in this embodiment of this disclosure, and generates a map based on decoded point cloud data, which is specifically described below.

In the point cloud attribute encoding and decoding system, a point cloud attribute encoding and decoding procedure may include the following three phases:

(1) Phase of Obtaining Point Cloud Data.

The point cloud data may be obtained in two manners: captured from a scene or generated by a device. Point cloud data captured from a scene may be point cloud data obtained by collecting a real-world visual scene by using a capture device. The capture device may be a hardware component disposed in the encoding device 201, for example, the capture device is a camera, a sensor, or the like of the terminal. The capture device may alternatively be a hardware apparatus connected to the encoding device 201, such as a camera connected to the server. The capture device is configured to provide an obtaining service of point cloud data for the encoding device 201. The capture device may include but is not limited to any one of the following: a camera device, a sensing device, and a scanning device. The camera device may include a common camera, a stereo camera, a light field camera, and the like. The sensing device may include a laser device, a radar device, and the like. The scanning device may include a three-dimensional laser scanning device, and the like. Point cloud data generated by a device may be point cloud data generated by a virtual object production device according to a virtual object (for example, a virtual three-dimensional object and a virtual three-dimensional scene that are obtained by means of three-dimensional modeling).

The point cloud data may include geometric information and real attribute information (e.g., color or reflectivity) of a to-be-encoded point. The real attribute information may be real reflection of an attribute. For example, in the point cloud data obtained in the foregoing manner of capturing from a device, real attribute information of any point may be real reflection of an attribute that is of the point in a visual scene of the real world and that is captured by the capture device. For another example, in the point cloud data obtained in the foregoing manner of generating by a device, real attribute information of any point may be a real attribute value that is of the point in a three-dimensional virtual object or a three-dimensional virtual scene and that is set in a virtual object production device.

(2) Encoding Phase of the Point Cloud Data.

After the capture device obtains the point cloud data, the encoding device 201 may divide to-be-encoded point cloud data into multiple point cloud groups, and the encoding device 201 may perform point cloud attribute encoding using a point cloud group as an encoding unit to obtain an attribute code of a point in each point cloud group. Then, the encoding device 201 may obtain a geometric code of points in each point cloud group. The encoding device 201 may establish a one-to-one correspondence between the attribute code and the geometric code of points in each point cloud group, generate encoded point cloud data according to the attribute code and the geometric code of points in each point cloud group, and transmit the encoded point cloud data to the decoding device 202.

(3) Decoding Phase of the Point Cloud Data.

After receiving to-be-decoded point cloud data transmitted by the encoding device 201 (that is, the encoded point cloud data), the decoding device 202 may divide the to-be-decoded point cloud data into multiple point cloud groups, and the decoding device 202 may perform point cloud attribute decoding using a point cloud group as a decoding unit, to obtain reconstruction attribute information of points in each point cloud group. Then, the decoding device 202 may obtain reconstruction geometric information of points in each point cloud group. The decoding device 202 may establish a one-to-one correspondence between the reconstruction attribute information and the reconstruction geometric information of points in each point cloud group, and reconstruct point cloud data according to the reconstruction attribute information and the reconstruction geometric information of points in each point cloud group.

By using three phases of the point cloud attribute encoding and decoding procedure in the point cloud attribute encoding and decoding system, decoding efficiency of the point cloud data can be improved at the decoder, and encoding efficiency of the point cloud data can be improved at the encoder. It may be understood that the point cloud attribute encoding and decoding system described in the embodiments of this disclosure is for more clearly describing the technical solutions in the embodiments of this disclosure, and does not constitute a limitation on the technical solutions provided in the embodiments of this disclosure. It should be understood that, with evolution of a network architecture and appearance of a new service scenario, the technical solutions provided in the embodiments of this disclosure also apply to a similar technical problem.

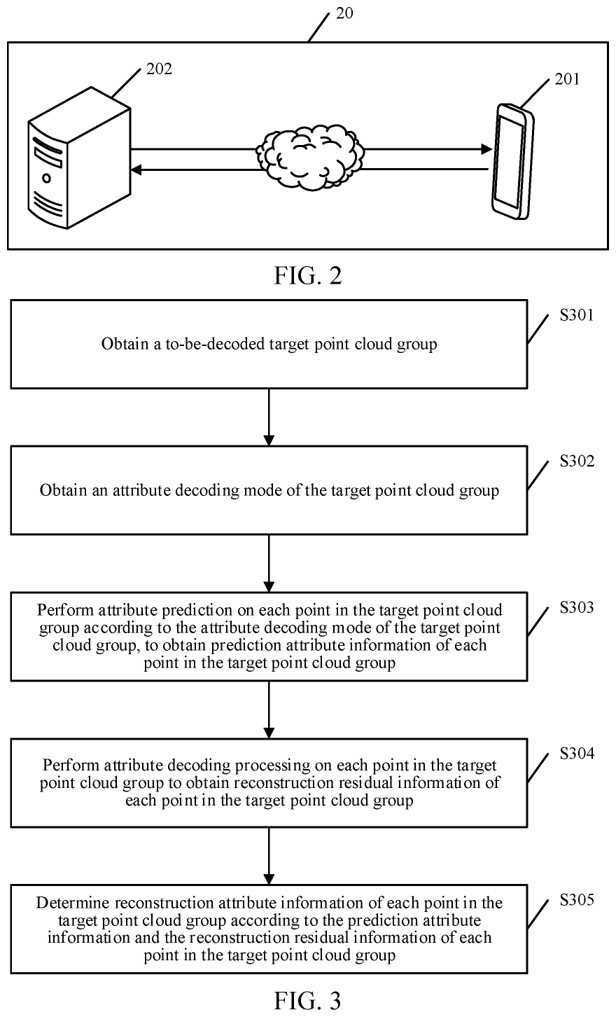

The following describes in more detail the point cloud attribute decoding solution and the point cloud attribute encoding solution according to the embodiments of this disclosure with reference to FIG. 3 to FIG. 7.

An embodiment of this disclosure provides a point cloud decoding method. The point cloud decoding method mainly describes an overall procedure of point cloud attribute decoding, a grouping manner of point cloud data, and a transform determining in point cloud attribute decoding. The point cloud decoding method may be performed by the decoding device 202 in the point cloud attribute encoding and decoding system 20. As shown in FIG. 3, the point cloud decoding method may include the following steps S301 to S305:

S301. Obtain a to-be-decoded target point cloud group.

It may be recognized from the foregoing content that the point cloud attribute decoding solution provided in this embodiment of this disclosure may be obtained by decoding to-be-decoded point cloud data by using a point cloud group as a decoding unit. Therefore, grouping processing is performed on the to-be-decoded point cloud data, and the to-be-decoded target point cloud group may be any point cloud group obtained by performing grouping processing on the to-be-decoded point cloud data.

A manner of performing grouping processing on the to-be-decoded point cloud data is described herein. The performing grouping processing on the to-be-decoded point cloud data may include but is not limited to any one of the following:

(1) Point cloud grouping manner of repeated point truncation. In an example, a process in which each to-be-decoded point in the to-be-decoded point cloud data is decoded sequentially according to a decoding sequence of the to-be-decoded point to perform grouping processing on the to-be-decoded point cloud data may include: performing grouping processing on one or more preceding points of a current to-be-decoded point according to a specified rule in a case that the current to-be-decoded point is a repeated point. The performing grouping processing on one or more preceding points of a current to-be-decoded point according to a specified rule may include any one of the following two cases: In a first case, if there is no repeated point in the preceding point of the current to-be-decoded point, that is, the current to-be-decoded point is the first repeated point in the to-be-decoded point cloud data, grouping processing may be performed on the one or more preceding points of the current to-be-decoded point according to the specified rule. In a second case, if one or more repeated points exist in the preceding point of the current to-be-decoded point, that is, the current to-be-decoded point is not the first repeated point in the to-be-decoded point cloud data, grouping processing may be performed on one or more preceding points of the current to-be-decoded point located between the current to-be-decoded point and a previous repeated point of the current to-be-decoded point.

The preceding point of the current to-be-decoded point may be a point whose decoding sequence is before that of the current to-be-decoded point. That the current to-be-decoded point is a repeated point may mean that geometric information of the current to-be-decoded point is the same as geometric information of any preceding point of the current to-be-decoded point. That geometric information of the current to-be-decoded point is the same as geometric information of the preceding point may mean that: Three-dimensional coordinates of the current to-be-decoded point are the same as three-dimensional coordinates of the preceding point, that is, the current to-be-decoded point is overlapped with the preceding point in three-dimensional space. The specified rule may refer to a grouping rule, and the point cloud grouping manner does not limit the grouping rule. For example, the grouping rule may include but is not limited to any one of the following: setting a grouping quantity threshold of each point cloud group (the grouping quantity threshold refers to a maximum quantity of points that each point cloud group allows to accommodate); grouping points arranged at odd-number positions into one point cloud group, and grouping points arranged at even-number positions into one point cloud group; and so on.

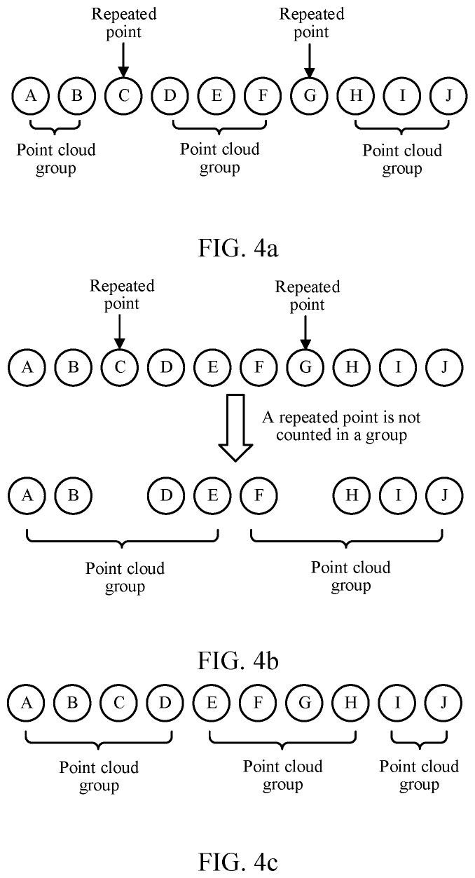

FIG. 4a is used as an example. A total of 10 points from a point A to a point J are sequentially decoded according to respective decoding sequences, and a grouping quantity threshold of each point cloud group is set to 3. If the point C is a repeated point, preceding points (the point A and the point B) of the point C may be grouped according to the grouping quantity threshold, and the point A and the point B are grouped into one point cloud group. Similarly, if the point G is a repeated point, preceding points (the point D, the point E, and the point F) of the point G located between the point C and the point G may be grouped according to the grouping quantity threshold, and the point D, the point E, and the point F are grouped into one point cloud group. There is no repeated point in the remaining point H, point I, and point J. The point H, the point I, and the point J may be grouped according to the grouping quantity threshold. The point H, the point I, and the point J are grouped into one point cloud group, and the grouping ends.

(2) Quantitative point cloud grouping manner in which a repeated point is not counted in a group. In an example, a process in which each to-be-decoded point in the to-be-decoded point cloud data is decoded sequentially according to a decoding sequence of the to-be-decoded point to perform grouping processing on the to-be-decoded point cloud data may include: skipping a current to-be-decoded point in a case that the current to-be-decoded point is a repeated point, adding a non-repeated point whose decoding sequence is after that of the current to-be-decoded point to a current point cloud group until a quantity of to-be-decoded points included in the current point cloud group reaches a grouping quantity threshold.

The preceding point of the current to-be-decoded point may be a point whose decoding sequence is before that of the current to-be-decoded point. That the current to-be-decoded point is a repeated point may mean that geometric information of the current to-be-decoded point is the same as geometric information of any preceding point of the current to-be-decoded point. That geometric information of the current to-be-decoded point is the same as geometric information of the preceding point may mean that: Three-dimensional coordinates of the current to-be-decoded point are the same as three-dimensional coordinates of the preceding point, that is, the current to-be-decoded point is overlapped with the preceding point in three-dimensional space. That any to-be-decoded point is a non-repeated point may mean that geometric information of the to-be-decoded point is different from geometric information of all preceding points of the to-be-decoded point. The grouping quantity threshold may refer to a maximum quantity of points that the current point cloud group allows to accommodate.

FIG. 4b is used as an example. A total of 10 points from a point A to a point J are sequentially decoded according to respective decoding sequences, and a grouping quantity threshold of each point cloud group is set to 4. A current point cloud group includes the point A and the point B. If the point C is a repeated point, the point C may be skipped, and a non-repeated point whose decoding sequence is after that of the point C is added to the current point cloud group until the grouping quantity threshold of the current point cloud group is met, that is, the point A, the point B, the point D, and the point E are grouped into one point cloud group. Similarly, the current point cloud group includes the point F. If the point G is a repeated point, the point G may be skipped, and a non-repeated point whose decoding sequence is after that of the point G is added to the current point cloud group until the grouping quantity threshold of the current point cloud group is met, that is, the point F, the point H, the point I, and the point J are grouped into one point cloud group, and the grouping ends.

(3) Quantitative point cloud grouping manner in which a repeated point is counted in a group. In an example, a process in which each to-be-decoded point in the to-be-decoded point cloud data is decoded sequentially according to a decoding sequence of the to-be-decoded point to perform grouping processing on the to-be-decoded point cloud data may include: adding a current to-be-decoded point to a current point cloud group in a case that the current to-be-decoded point is a repeated point; and adding, in a case that a quantity of points included in the current point cloud group does not reach a grouping quantity threshold, a to-be-decoded point whose decoding sequence is after that of the current to-be-decoded point to the current point cloud group until the quantity of points included in the current point cloud group reaches the grouping quantity threshold.

The preceding point of the current to-be-decoded point may be a point whose decoding sequence is before that of the current to-be-decoded point. That the current to-be-decoded point is a repeated point may mean that geometric information of the current to-be-decoded point is the same as geometric information of any preceding point of the current to-be-decoded point. That geometric information of the current to-be-decoded point is the same as geometric information of the preceding point may mean that: Three-dimensional coordinates of the current to-be-decoded point are the same as three-dimensional coordinates of the preceding point, that is, the current to-be-decoded point is overlapped with the preceding point in three-dimensional space. The grouping quantity threshold may refer to a maximum quantity of points that the current point cloud group allows to accommodate.

FIG. 4c is used as an example. A total of 10 points from a point A to a point J are sequentially decoded according to respective decoding sequences, and a grouping quantity threshold of each point cloud group is set to 4. A current point cloud group includes the point A and the point B. If the point C is a repeated point, the point C may be added to the current point cloud group. In this case, the current point cloud group includes the point A, the point B, and the point C. If the current point cloud group does not meet the grouping quantity threshold, a non-repeated point whose decoding sequence is after that of the point C may be added to the current point cloud group until the grouping quantity threshold of the current point cloud group is met, that is, the point A, the point B, the point C, and the point D are grouped into one point cloud group. Similarly, the current point cloud group includes the point E and the point F, and if the point G is a repeated point, the point G may be added to the current point cloud group. In this case, the current point cloud group includes the point E, the point F, and the point G. When the current point cloud group does not meet the grouping quantity threshold, and a non-repeated point whose decoding sequence is after that of the point G may be added to the current point cloud group until the grouping quantity threshold of the current point cloud group is met, that is, the point E, the point F, the point G, and the point H are grouped into one point cloud group. There is no repeated point in the remaining point I and point J. The point I and the point J may be grouped according to the grouping quantity threshold. The point I and the point J are grouped into one point cloud group, and the grouping ends.

(4) Point cloud grouping manner in which a repeated point is counted in a group.

In an example, a process in which each to-be-decoded point in the to-be-decoded point cloud data is decoded sequentially according to a decoding sequence of the to-be-decoded point to perform grouping processing on the to-be-decoded point cloud data may include: performing, in a case that a current to-be-decoded point is a repeated point, grouping processing on the repeated point. The preceding point of the current to-be-decoded point may be a point whose decoding sequence is before that of the current to-be-decoded point. That the current to-be-decoded point is a repeated point may mean that geometric information of the current to-be-decoded point is the same as geometric information of any preceding point of the current to-be-decoded point. That geometric information of the current to-be-decoded point is the same as geometric information of the preceding point may mean that: Three-dimensional coordinates of the current to-be-decoded point are the same as three-dimensional coordinates of the preceding point, that is, the current to-be-decoded point is overlapped with the preceding point in three-dimensional space. That is, a repeated point is counted in a group in the point cloud grouping manner, but the point cloud grouping manner does not limit the grouping rule. For example, the grouping rule may include but is not limited to any one of the following: setting a grouping quantity threshold of each point cloud group (the grouping quantity threshold refers to a maximum quantity of points that each point cloud group allows to accommodate), that is, the solution described in (3) above; grouping points arranged at odd-number positions into one point cloud group, and grouping points arranged at even-number positions into one point cloud group; and so on.

(5) Point cloud grouping manner of determining a quantity of repeated points. In an example, a process in which each to-be-decoded point in the to-be-decoded point cloud data is decoded sequentially according to a decoding sequence of the to-be-decoded point to perform grouping processing on the to-be-decoded point cloud data may include: skipping performing grouping processing on a current to-be-decoded point in a case that the current to-be-decoded point is a repeated point, and a quantity of counted repeated points is greater than a first quantity threshold; and performing grouping processing on the current to-be-decoded point in a case that the current to-be-decoded point is a repeated point, but the quantity of counted repeated points is less than or equal to the first quantity threshold.

The preceding point of the current to-be-decoded point may be a point whose decoding sequence is before that of the current to-be-decoded point. That the current to-be-decoded point is a repeated point may mean that geometric information of the current to-be-decoded point is the same as geometric information of any preceding point of the current to-be-decoded point. That geometric information of the current to-be-decoded point is the same as geometric information of the preceding point may mean that: Three-dimensional coordinates of the current to-be-decoded point are the same as three-dimensional coordinates of the preceding point, that is, the current to-be-decoded point is overlapped with the preceding point in three-dimensional space. The quantity of counted repeated points may refer to: a quantity obtained after a quantity of repeated points existing in preceding points of the current to-be-decoded point plus 1 (that is, plus the current to-be-decoded point).

That is, in the point cloud grouping manner, when the current to-be-decoded point is a repeated point and the quantity of counted repeated points is greater than the first quantity threshold, the current to-be-decoded point may not be included in the point cloud group; and when the current to-be-decoded point is a repeated point and the quantity of counted repeated points is less than or equal to the first quantity threshold, the current to-be-decoded point may be included in the point cloud group. In addition, the point cloud grouping manner does not limit the grouping rule. For example, the grouping rule may include but is not limited to any one of the following: setting a grouping quantity threshold of each point cloud group (the grouping quantity threshold refers to a maximum quantity of points that each point cloud group allows to accommodate); grouping points arranged at odd-number position into one point cloud group, and grouping points arranged at even-number positions into one point cloud group; and so on.

(6) Point cloud grouping manner based on similar sorting codes. Before introducing this manner, a re-sorting process is described as follows: Sorting codes of to-be-decoded points may be obtained, and then the to-be-decoded points are sorted in ascending order or ascending order of the sorting codes of the to-be-decoded points. For example, a sorting code of any to-be-decoded point may be obtained by performing transform processing on geometric information of the to-be-decoded point (the transform processing herein may be referred to as first transform processing). For example, the first transform processing may be a Hilbert code obtained by performing Hilbert transform on the geometric information of the to-be-decoded point, and the to-be-decoded points may be sorted in ascending order or descending order of Hilbert codes of the to-be-decoded points.

After the re-sorting process is described, the point cloud grouping manner based on similar sorting codes is described herein. In an example, a process in which each to-be-decoded point in the to-be-decoded point cloud data is decoded sequentially according to a decoding sequence of the to-be-decoded point to perform grouping processing on the to-be-decoded point cloud data may include: first, re-sorting may be performed on each to-be-decoded point (this step may be ignored for each re-sorted to-be-decoded point); and then, points with the same last L bits in the sorting codes may be grouped into one point cloud group. An initial value of L may be represented as L_base. For a calculation manner of L_base, refer to the following formula 1:

$$L\_base \approx 3 \times ( Log 2 ( maxSize ) - \frac{Log 2 ( \frac{H}{{K}_{mean}} )}{2} ) \qquad Formula 1$$

Parameters in formula 1 are explained herein: L_base is the initial value of L, and L is a sorting code bit used for grouping processing; H represents a total quantity of to-be-decoded points; maxSize represents a maximum side length size obtained after geometric information fixed-point processing of a to-be-decoded point, where geometric information fixed-point processing refers to preprocessing geometric information, the maximum side length size refers to a maximum distance between any two to-be-decoded points after preprocessing, and the distance herein may refer to a Manhattan distance or a Euclidean distance between any two to-be-decoded points, and the like; and Kₘₑₐₙ represents an average value of a quantity of to-be-decoded points included in each point cloud group obtained by means of expected grouping processing, and may be set according to an actual requirement. For example, Kₘₑₐₙ may be set to 4.

For a problem that the quantity of to-be-decoded points included in each point cloud group may be unbalanced in the point cloud grouping manner, the size of L may be dynamically adjusted. An adjustment rule is that an average value of a quantity of to-be-decoded points included in a point cloud group obtained by means of grouping is counted, and if the average value is less than a first value (for example, may be 2), L=L+m; if the average value is greater than a second value (for example, may be 7), L=L−m; and otherwise, L remains unchanged. The second value is greater than the first value, and m may be a constant, for example, m may be 3.

(7) Point cloud grouping manner based on sorting code shift. In an example, a process in which each to-be-decoded point in the to-be-decoded point cloud data is decoded sequentially according to a decoding sequence of the to-be-decoded point to perform grouping processing on the to-be-decoded point cloud data may include: re-sorting each to-be-decoded point (this step may be ignored for a re-sorted to-be-decoded point); performing target shift bit-based processing (for example, rightward shift processing) on a sorting code (for example, may be the foregoing Hilbert code) of each to-be-decoded point; grouping to-be-decoded points having the same shift-processed sorting code into one point cloud block, where a repeated point is not counted in the point cloud block; for any point cloud block, if a quantity of to-be-decoded points included in the point cloud block is less than or equal to the grouping quantity threshold, the point cloud block may be determined as one point cloud group; and if the quantity of to-be-decoded points included in the point cloud block is greater than the grouping quantity threshold, grouping processing may be performed on the point cloud block according to the grouping quantity threshold. For a process of determining the target shift bit, refer to the following formula 2 to formula 4:

$$shiftBits = max ( 3 , 3 * ( \frac{MaxBits - MinBits}{3} ) ) \qquad Formula 2$$

$$MaxBits = {log}_{2} ( long \times width \times height ) \qquad Formula 3$$

$$MinBits = {log}_{2} voxelCount \qquad Formula 4$$

Parameters in formula 2 to formula 4 are explained herein: shiftBits indicates the target shift bit; voxelCount represents a total quantity of to-be-decoded points; long represents a length of a bounding box of all to-be-decoded points; width represents a width of the bounding box of all to-be-decoded points; and height represents a height of the bounding box of all to-be-decoded points.

In the point cloud grouping manners described in the foregoing (1) to (7), for a point cloud grouping manner in which a repeated point is not counted in a point cloud group, similar points may be more centralized, and decoding of duplicate information may be reduced in a decoding process, thereby improving decoding efficiency. For a point cloud grouping manner in which a repeated point is counted in a point cloud group, a quantity of repeated points existing in to-be-decoded point cloud data is generally relatively small (for example, the foregoing mentioned quantity of counted repeated points is less than or equal to the first quantity threshold), which has little impact on decoding efficiency.

S302. Obtain an attribute decoding mode of the target point cloud group.

The target point cloud group may include one or more to-be-decoded points. After the to-be-decoded target point cloud group is obtained, the attribute decoding mode of the target point cloud group may be obtained. The attribute decoding mode is a method or a policy used for predicting a prediction attribute value of each point in the target point cloud group in a decoding phase of the target point cloud group. The attribute decoding mode may include an intra-group attribute decoding mode or an inter-group attribute decoding mode. The intra-group attribute decoding mode may refer to: determining, according to prediction attribute information of a target point in the target point cloud group, an attribute decoding mode of a prediction attribute information of a point other than the target point in the target point cloud group, where a quantity of target points may be one or more; or may refer to: separately determining an attribute decoding mode of prediction attribute information of each point in the target point cloud group. The inter-group attribute decoding mode may refer to: determining an attribute decoding mode of prediction attribute information of each point in the target point cloud group according to reconstruction attribute information of the point in the associated point cloud group of the target point cloud group.

Attribute decoding modes of any two point cloud groups obtained by performing grouping processing on the to-be-decoded point cloud data may be the same or different. For example, the target point cloud group is any point cloud group obtained by performing grouping processing on to-be-decoded point cloud data; grouping processing may be performed on the to-be-decoded point cloud data to further obtain a first point cloud group, where the first point cloud group is any point cloud group other than the target point cloud group, that is, the target point cloud group and the first point cloud group are any two point cloud groups obtained by performing grouping processing on the to-be-decoded point cloud data; an attribute decoding mode of the first point cloud group is different from the attribute decoding mode of the target point cloud group; or an attribute decoding mode of the first point cloud group is the same as the attribute decoding mode of the target point cloud group.

S303. Perform attribute prediction on each point in the target point cloud group according to the attribute decoding mode of the target point cloud group, to obtain prediction attribute information of each point in the target point cloud group.

After the attribute decoding mode in the target point cloud group is obtained, attribute prediction may be performed on each point in the target point cloud group according to the attribute decoding mode in the target point cloud group, to obtain the prediction attribute information of each point in the target point cloud group, where the prediction attribute information of any point in the target point cloud group refers to attribute information of the point obtained by prediction.

When the attribute decoding mode of the target point cloud group is the inter-group attribute decoding mode, the performing attribute prediction on each point in the target point cloud group according to the inter-group attribute decoding mode to obtain attribute prediction information of each point in the target point cloud group may include: determining M associated point cloud groups of the target point cloud group from point cloud groups obtained by performing grouping processing on to-be-decoded point cloud data, the M associated point cloud groups being M neighboring point cloud groups before the target point cloud group in the point cloud groups obtained by performing grouping processing on the to-be-decoded point cloud data and whose decoding sequences are before that of the target point cloud group, and M being a positive integer; and determining the prediction attribute information of each point in the target point cloud group according to the reconstruction attribute information of each point in the M associated point cloud groups. To facilitate understanding of the M associated point cloud groups of the target point cloud group, for example, the point cloud group obtained by performing grouping processing on the to-be-decoded point cloud data may be represented as a point cloud group 1 and a point cloud group 2 . . . . A decoding sequence of the point cloud group 1 is before a decoding sequence of the point cloud group 2, and the decoding sequence of the point cloud group 2 is located before a decoding sequence of the point cloud group 3. By analogy, three associated point cloud groups of a point cloud group 5 are respectively the point cloud group 2, the point cloud group 3, and a point cloud group 4.

When the attribute decoding mode of the target point cloud group is the intra-group attribute decoding mode, the performing attribute prediction on each point in the target point cloud group according to the intra-group attribute decoding mode to obtain attribute prediction information of each point in the target point cloud group may include: separately determining the prediction attribute information of each point in the target point cloud group; or determining the prediction attribute information of the target point in the target point cloud group, and determining the prediction attribute information of each point in the target point cloud group according to the prediction attribute information of the target point.

S304. Perform attribute decoding processing on each point in the target point cloud group to obtain reconstruction residual information of each point in the target point cloud group.

Before step S304 in this embodiment of this disclosure is introduced, in this embodiment of this disclosure, an execution process of step S303 and step S304 is not successively performed. In this embodiment of this disclosure, the performing attribute decoding processing on each point in the target point cloud group to obtain reconstruction residual information of each point in the target point cloud group may include any one of the following cases:

(1) Attribute prediction decoding. Attribute prediction decoding is corresponding to attribute prediction encoding. Using the target point cloud group as an example, a process of attribute prediction encoding may include: performing attribute encoding processing on prediction residual information of each point in the target point cloud group to obtain an encoded target point cloud group, that is, to obtain an attribute code of each point in the target point cloud group. Correspondingly, in the attribute prediction decoding manner, the performing attribute decoding processing on each point in the target point cloud group to obtain reconstruction residual information of each point in the target point cloud group may include: performing attribute decoding processing on each point in the target point cloud group to obtain reconstruction residual information of each point in the target point cloud group. The performing attribute decoding processing on each point in the target point cloud group to obtain reconstruction residual information of each point in the target point cloud group may specifically include: Decoding processing (for example, may be entropy decoding processing) may be performed on the attribute code of each point in the target point cloud group to obtain a reconstruction quantization value of each point in the target point cloud group. Then, dequantization processing may be performed on the reconstruction quantization value of each point in the target point cloud group to obtain the reconstruction residual information of each point in the target point cloud group.

(2) Attribute predicting transform decoding. Attribute predicting transform decoding is corresponding to attribute predicting transform encoding. Using the target point cloud group as an example, a process of attribute predicting transform encoding may include: performing transform processing on prediction residual information of each point in the target point cloud group (the transform processing herein may refer to second transform processing), to obtain a residual transform coefficient of each point in the target point cloud group, and then attribute encoding processing may be performed on the residual transform coefficient of each point in the target point cloud group to obtain an encoded target point cloud group, that is, to obtain an attribute code of each point in the target point cloud group. Correspondingly, in the attribute predicting transform decoding manner, the performing attribute decoding processing on each point in the target point cloud group to obtain reconstruction residual information of each point in the target point cloud group may include: performing attribute decoding processing on each point in the target point cloud group to obtain a reconstruction transform coefficient of each point in the target point cloud group, and performing inverse transform processing on the reconstruction transform coefficient of each point in the target point cloud group to obtain the reconstruction residual information of each point in the target point cloud group.

The performing attribute decoding processing on each point in the target point cloud group to obtain a reconstruction transform coefficient of each point in the target point cloud group may specifically include: Decoding processing (for example, may be entropy decoding processing) may be performed on the attribute code of each point in the target point cloud group to obtain a reconstruction quantization value of each point in the target point cloud group. Then, inverse transform processing may be performed on the reconstruction quantization value of each point in the target point cloud group to obtain the reconstruction transform coefficient of each point in the target point cloud group. In addition, inverse transform processing herein is corresponding to the foregoing second transform processing. The second transform processing may be, for example, performing discrete cosine transform (DCT) processing on the prediction residual information of each point in the target point cloud group, where the DCT transform belongs to orthogonal transform, the orthogonal transform does not change an information source entropy value, reconstruction residual information can be obtained by means of inverse transform processing, and a degree of encoding of the prediction residual information obtained after the DCT transform is high. Transform processing is performed on the prediction residual information of each point in the target point cloud group, and the obtained residual transform coefficient of each point in the target point cloud group may include a direct current (DC) coefficient and an alternating current (AC) coefficient. During attribute encoding processing, the DC coefficient and the AC coefficient are separately encoded. The inverse transform processing may be, for example, performing inverse discrete cosine transform (IDCT) processing on the reconstruction transform coefficient of each point in the target point cloud group.

(3) Attribute decoding for transform determining. In the foregoing (1), attribute prediction decoding processing may be directly performed on the target point cloud group to obtain the reconstruction residual information of each point in the target point cloud group. In the foregoing (2), attribute predicting transform decoding processing may be directly performed on the target point cloud group to obtain the reconstruction residual information of each point in the target point cloud group. Based on this, attribute decoding for transform determining is proposed, that is, a transform determining process for the target point cloud group is added. The attribute prediction decoding in the foregoing (1) needs to be used for determining the target point cloud group, or the attribute predicting transform decoding in the foregoing (2) needs to be used. In an example, transform determining may be performed on the target point cloud group. If the target point cloud group meets a transform condition, attribute decoding processing may be performed on each point in the target point cloud group to obtain a reconstruction transform coefficient of each point in the target point cloud group, and inverse transform processing is performed on the reconstruction transform coefficient of each point in the target point cloud group to obtain the reconstruction residual information of each point in the target point cloud group, that is, the foregoing (2). If the target point cloud group does not meet the transform condition, attribute decoding processing may be performed on each point in the target point cloud group to obtain the reconstruction residual information of each point in the target point cloud group, that is, the foregoing (1).

That the target point cloud group meets the transform condition may include any one of the following: A quantity of points included in the target point cloud group meets a quantity condition. For example, the quantity of points included in the target point cloud group is greater than or equal to a transform quantity threshold, and the quantity of points included in the target point cloud group is an odd number (or an even number). Alternatively, distribution of the reconstruction residual information of each point in the target point cloud group meets a distribution condition, for example, a difference between maximum reconstruction residual information and minimum reconstruction residual information in the reconstruction residual information of each point in the target point cloud group is less than or equal to a distribution threshold, and a variance of the reconstruction residual information of each point in the target point cloud group is less than or equal to a variance threshold.

That the target point cloud group does not meet the transform condition may include any one of the following: The quantity of points included in the target point cloud group does not meet the quantity condition, where the quantity condition may be whether the quantity of points included in the target point cloud group is greater than or equal to the transform quantity threshold, whether the quantity of points included in the target point cloud group is an odd number (or an even number), or the like. For example, a case in which the quantity of points included in a target point cloud group does not meet the quantity condition may be as follows: The quantity of points included in the target point cloud group is less than the transform quantity threshold, the quantity of points included in the target point cloud group is an even number (or an odd number), and the like. Alternatively, distribution of the reconstruction residual information of each point in the target point cloud group does not meet the distribution condition, where the distribution condition may be a case in which the difference between the maximum reconstruction residual information and the minimum reconstruction residual information in the reconstruction residual information of each point in the target point cloud group is less than or equal to the distribution threshold, and the variance of the reconstruction residual information of each point in the target point cloud group is less than or equal to the variance threshold. For example, that distribution of the reconstruction residual information of each point in the target point cloud group does not meet the distribution condition may be as follows: The difference between the maximum reconstruction residual information and the minimum reconstruction residual information in the reconstruction residual information of each point in the target point cloud group is greater than the distribution threshold, the variance of the reconstruction residual information of each point in the target point cloud group is greater than the variance threshold, and the like.

S305. Determine reconstruction attribute information of each point in the target point cloud group according to the prediction attribute information and the reconstruction residual information of each point in the target point cloud group.

After the prediction attribute information and the reconstruction residual information of each point in the target point cloud group are obtained, the reconstruction attribute information of each point in the target point cloud group may be determined according to the prediction attribute information and the reconstruction residual information of each point in the target point cloud group. Reconstruction attribute information of any point in the target point cloud group may be equal to a sum of prediction attribute information of the point and reconstruction residual information of the point.

In this embodiment of this disclosure, in a process of performing grouping processing on the to-be-decoded point cloud data, a repeated point may not be counted in a group. In this way, decoding of repetition information can be reduced, so that similar points are more centralized, and decoding efficiency is improved. In addition, attribute decoding modes of any two point cloud groups obtained by performing grouping processing on the to-be-decoded point cloud data may be different. By designing differentiated attribute decoding modes in different point cloud groups, accuracy of attribute prediction performed on the point cloud group can be ensured. In addition, when the target point cloud group meets the transform condition, inverse transform processing may be performed on the reconstruction residual information of each point in the target point cloud group, which can improve accuracy of the decoding process.

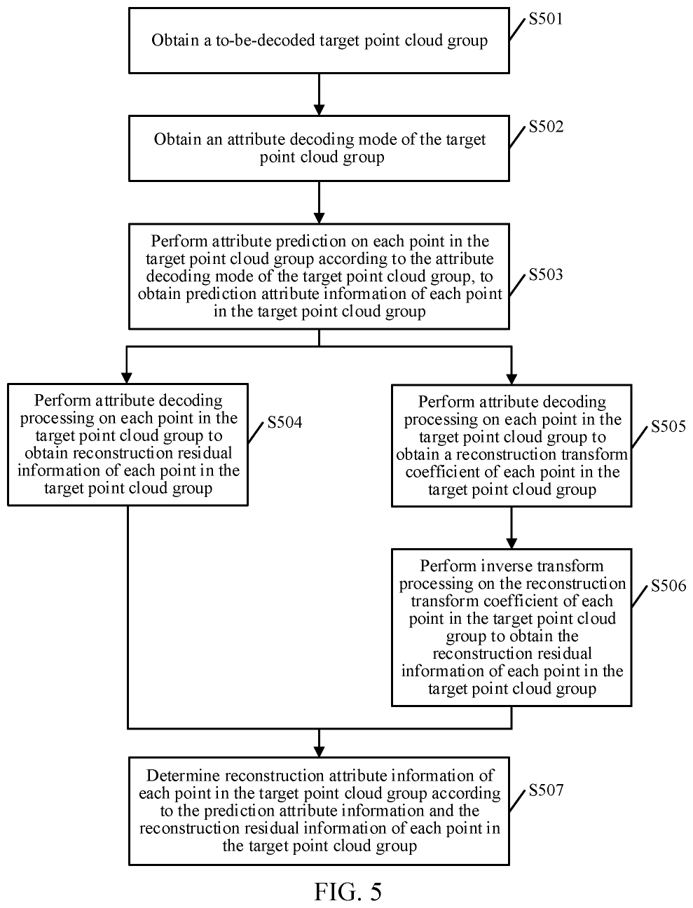

An embodiment of this disclosure provides a point cloud decoding method. The point cloud decoding method mainly describes a process of determining an attribute decoding mode of a target point cloud group and an attribute prediction process of the target point cloud group. The point cloud decoding method may be performed by the decoding device 202 in the point cloud attribute encoding and decoding system 20. As shown in FIG. 5, the point cloud decoding method may include the following steps S501 to S507:

S501. Obtain a to-be-decoded target point cloud group.

An execution process of step S501 in this embodiment of this disclosure is the same as an execution process of step S301 in the embodiment shown in FIG. 3. For details, refer to the execution process of step S301 in the embodiment shown in FIG. 3. Details are not described herein again.

S502. Obtain an attribute decoding mode of the target point cloud group.

It may be understood from the foregoing content that the attribute decoding mode of the target point cloud group may include an inter-group attribute decoding mode and an intra-group attribute decoding mode, and the attribute decoding mode of the target point cloud group may be determined based on an inter-group similarity manner. The following describes the inter-group similarity manner to obtain the attribute decoding mode of the target point cloud group, which may include: determining M associated point cloud groups of the target point cloud group from point cloud groups obtained by performing grouping processing on to-be-decoded point cloud data, the M associated point cloud groups being M neighboring point cloud groups before the target point cloud group in the point cloud groups obtained by performing grouping processing on the to-be-decoded point cloud data and whose decoding sequences are before that of the target point cloud group, and M being a positive integer; calculating inter-group similarity between the target point cloud group and the M associated point cloud groups; determining that the attribute decoding mode of the target point cloud group is the inter-group attribute decoding mode in a case that the inter-group similarity is greater than a similarity threshold; and determining that the attribute decoding mode of the target point cloud group is the intra-group attribute decoding mode in a case that the inter-group similarity is less than or equal to the similarity threshold.

The inter-group similarity may include inter-group geometric similarity. The inter-group geometric similarity may be obtained by means of calculation according to the geometric information of each point in the target point cloud group and geometric information of each point in the M associated point cloud groups. For example, a distance between each point in the target point cloud group and each point in the M associated point cloud groups may be calculated according to the geometric information of each point in the target point cloud group and the geometric information of each point in the M associated point cloud groups. Then, a distance sum of the points in the target point cloud group may be calculated, and a reciprocal obtained after the distance sum is determined as inter-group geometric similarity. A larger value of the inter-group geometric similarity indicates higher similarity between the target point cloud group and the M associated point cloud groups.

That is, in the inter-group similarity manner, the attribute decoding mode of the target point cloud group is selected by using the similarity between the target point cloud group and the associated point cloud group of the target point cloud group. When the similarity between the target point cloud group and the associated point cloud group is high, the inter-group attribute decoding mode may be used as the attribute decoding mode of the target point cloud group. When the similarity between the target point cloud group and the associated point cloud group is low, the inter-group attribute decoding mode may be used as the attribute decoding mode of the target point cloud group.

S503. Perform attribute prediction on each point in the target point cloud group according to the attribute decoding mode of the target point cloud group, to obtain prediction attribute information of each point in the target point cloud group.

When the attribute decoding mode of the target point cloud group is the inter-group attribute decoding mode, a process in which attribute prediction is performed on each point in the target point cloud group according to the attribute decoding mode of the target point cloud group to obtain the prediction attribute information of each point in the target point cloud group may specifically include any one of the following two types:

(1) determining M associated point cloud groups of the target point cloud group from point cloud groups obtained by performing grouping processing on to-be-decoded point cloud data, the M associated point cloud groups being M neighboring point cloud groups before the target point cloud group in the point cloud groups obtained by performing grouping processing on the to-be-decoded point cloud data and whose decoding sequences are before that of the target point cloud group, and M being a positive integer; and then, determining an average value of reconstruction attribute information of each point in the M associated point cloud groups as the prediction attribute information of each point in the target point cloud group. That is, a uniform prediction attribute value is used for each point in the target point cloud group, and the uniform prediction attribute value is an average value of the reconstruction attribute information of each point in the M associated point cloud groups.

(2) determining M associated point cloud groups of the target point cloud group from point cloud groups obtained by performing grouping processing on to-be-decoded point cloud data, the M associated point cloud groups being M neighboring point cloud groups before the target point cloud group in the point cloud groups obtained by performing grouping processing on the to-be-decoded point cloud data and whose decoding sequences are before that of the target point cloud group, and M being a positive integer; then, determining an associated point of each point in the target point cloud group from the M associated point cloud groups; and determining the prediction attribute information of each point in the target point cloud group according to reconstruction attribute information of the associated point of each point in the target point cloud group. That is, prediction attribute information of any point in the target point cloud group is determined according to reconstruction attribute information of an associated point of the point.

An associated point of any point in the target point cloud group may be one or more points that are in the M associated point cloud groups and that have a close distance from the point. When any point in the target point cloud group (for example, may be represented as an ith point, and i is a positive integer) is a point that is in the M associated point cloud groups and that has a close distance from the any point, prediction attribute information of the ith point is equal to reconstruction attribute information of the associated point. When any point in the target point cloud group (for example, may be represented as an ith point, and i is a positive integer) is multiple points that are in the M associated point cloud groups and that are close to the ith point, prediction attribute information of the ith point is equal to an average value or a weighted average value of reconstruction attribute information of the multiple associated points, and a weight of any associated point may be determined according to a distance between the associated point and the ith point, for example, may be a reciprocal of the distance between the associated point and the ith point.

When the attribute decoding mode of the target point cloud group is the intra-group attribute decoding mode, the process in which attribute prediction is performed on each point in the target point cloud group according to the attribute decoding mode of the target point cloud group to obtain the prediction attribute information of each point in the target point cloud group may include the following sub-step s11 and sub-step s12:

s11. Determine prediction attribute information of a target point in the target point cloud group.

In an implementation, the target point may be any one or more points in the target point cloud group. For example, the target point may be a point in the target point cloud group that is ranked first, or may be a point in the target point cloud group that is ranked last, or may be a point in the target point cloud group that is ranked first and a point in the target point cloud group that is ranked last.

In another implementation, grouping processing may be performed on the target point cloud group to obtain P point cloud sub-groups, where P is an integer greater than or equal to 2; and one point may be selected from each point cloud sub-group of the P point cloud sub-groups as a target point. That is, each point cloud sub-group of the P point cloud sub-groups includes one target point. For example, the target point of each point cloud sub-group may be a point that is ranked first in the point cloud sub-group.

In the foregoing two implementations, a manner of determining the prediction attribute information of the target point may include any one of the following two cases:

(1) determining reconstruction attribute information of a neighboring point whose decoding sequence is before that of the target point in the target point cloud group as the prediction attribute information of the target point. For example, the target point in the target point cloud group may be represented as an ith point, prediction attribute information of the ith point may be determined according to reconstruction attribute information of an (i−1)th point, and i is an integer greater than 1.

(2) determining Q neighboring points of the target point in a point cloud group obtained by performing grouping processing on to-be-decoded point cloud data, Q being a positive integer; determining a geometric relationship between the Q neighboring points and the target point; and determining a prediction attribute value of the target point according to the geometric relationship between the Q neighboring points and the target point and reconstruction attribute information of the Q neighboring points; the Q neighboring points being Q points that are in the point cloud group obtained by performing grouping processing on the to-be-decoded point cloud data and that are geometrically close to the target point.

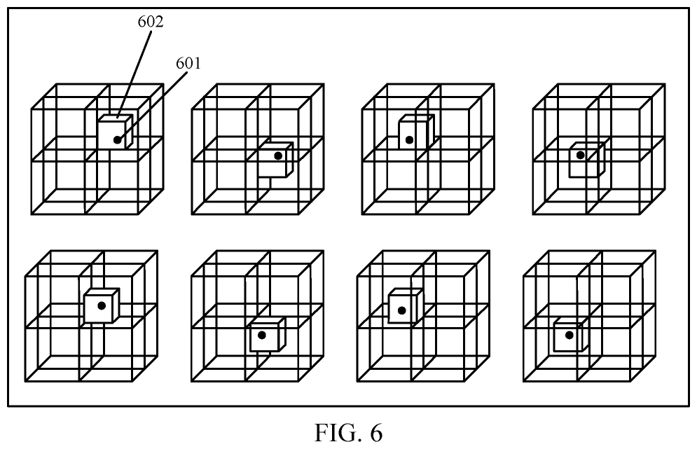

The determining Q neighboring points of the target point in the point cloud group obtained by performing grouping processing on the to-be-decoded point cloud data may include any one of the following two cases: In a first case, points in point cloud groups obtained by performing grouping processing on the to-be-decoded point cloud data may be re-sorted. For example, the points are re-sorted according to the foregoing Hilbert codes of the points in the point cloud groups obtained by means of grouping processing, and then Q points that are closest to the target point (for example, may be the Manhattan distance or the Euclidean distance mentioned above) are searched for in a maximum quantity of neighboring points arranged before the target point in a re-sorted point cloud sequence. maxNumOfNeighbours refers to a maximum quantity of points to be searched when searching for neighboring points, for example, a value of maxNumOfNeighbours may be 128, and a value of Q may be 3. In a second case, as shown in FIG. 6, point cloud blocking may be performed on each point in the point cloud group obtained by means of grouping processing. For a specific manner of point cloud blocking, references may be made to the foregoing description. A large-volume block shown in FIG. 6 may be referred to as a point cloud parent block, and a small-volume block may be referred to as a point cloud child block. Then, Q points closest to the target point (for example, the Manhattan distance or the Euclidean distance) may be searched for in a point cloud sub-block 602 to which a target point 601 belongs and neighboring point cloud sub-blocks (for example, seven neighboring point cloud sub-blocks of the point cloud sub-block 602 shown in FIG. 6) that are in the same plane, the same line, and the same point as the point cloud sub-block to which the target point 601 belongs as neighboring points.

A geometric relationship between the Q neighboring points and the target point may refer to distances between the Q neighboring points and the target point. A process of determining a prediction attribute value of the target point according to the geometric relationship between the Q neighboring points and the target point and reconstruction attribute information of the Q neighboring points may include: determining weights of the Q neighboring points according to the distance between each neighboring point of the Q neighboring points and the target point, and weighted summation of reconstruction attribute information of the Q neighboring points according to the weights of the Q neighboring points, to obtain the prediction attribute information of the target point. For a process of determining the prediction attribute value of the target point according to the geometric relationship between the Q neighboring points and the target point and the reconstruction attribute information of the Q neighboring points, refer to the following formula 5 to formula 7:

$${\hat{A}}_{i} = \frac{{\sum }_{j = 1}^{Q} {w}_{ij} {\hat{A}}_{ij}}{{\sum }_{j = 1}^{Q} {w}_{ij}} \qquad Formula 5$$

$${w}_{ij} = \frac{1}{d} \qquad Formula 6$$

$$d = \vert {x}_{i} - {x}_{ij} \vert + \vert {y}_{i} - {y}_{ij} \vert + \vert {z}_{i} - {z}_{ij} \vert \qquad Formula 7$$

In this case, the target point may be represented as an ith point, any one of the Q associated points of the target point may be represented as a jth associated point, i is a positive integer, and j is a positive integer less than or equal to Q. Based on this, parameters in the foregoing formula 5 to formula 7 are explained. Âᵢ represents prediction attribute information of the ith point; wᵢⱼ represents a weight of the jth associated point; Âᵢⱼ represents reconstruction attribute information of the jth associated point; d represents a distance between the ith point and the jth associated point (the Manhattan distance is used as an example herein); (xᵢ, yᵢ, zᵢ) represents geometric information of the ith point, that is, three-dimensional coordinates of the ith point; and (xᵢⱼ, yᵢⱼ, zᵢⱼ) represents geometric information of the jth associated point, that is, three-dimensional coordinates of the jth associated point.

s12. Determine the prediction attribute information of each point in the target point cloud group according to the prediction attribute information of the target point.

A manner of determining the prediction attribute information of each point in the target point cloud group according to the prediction attribute information of the target point may include any one of the following four cases:

(1) determining the prediction attribute information of the target point as the prediction attribute information of each point in the target point cloud group in a case that the target point is any point in the target point cloud group, which may specifically include: The prediction attribute information of the target point may be determined as the prediction attribute information of each point in the target point cloud group. That is, each point in the target point cloud group uses uniform prediction attribute information, and the uniform prediction attribute information is the prediction attribute information of the target point.

(2) determining the prediction attribute information of the target point as the prediction attribute information of each point in the target point cloud group in a case that the target point is any point in the target point cloud group, which may specifically include: determining a geometric relationship between another point in the target point cloud group except the target point and the target point; and determining prediction attribute information of the another point according to the geometric relationship between the another point and the target point and the prediction attribute information of the target point.

The geometric relationship between the another point and the target point may refer to a distance between the another point and the target point. A process of determining prediction attribute information of the another point according to the geometric relationship between the another point and the target point and the prediction attribute information of the target point may include: determining a weight of each another point according to a distance between the another point and the target point, where the weight of any another point may be a reciprocal of the distance between the another point and the target point; and weighted summation is performed on prediction attribute information of each another point according to the weight of each another point, to obtain the prediction attribute information of the target point.

(3) determining the prediction attribute information of the target point as the prediction attribute information of each point in the target point cloud group in a case that the target point is any multiple points in the target point cloud group, which may specifically include: determining an average value of the prediction attribute information of the multiple target points as the prediction attribute information of each point in the target point cloud group. That is, each point in the target point cloud group uses uniform prediction attribute information, and the uniform prediction attribute information is an average value of the prediction attribute information of the multiple target points.

(4) When a target point is included in each point cloud sub-group in P point cloud sub-groups obtained by performing grouping processing on the target point cloud group, prediction attribute information of the target point in each point cloud sub-group in the P point cloud sub-groups may be determined as prediction attribute information of each point in the corresponding point cloud sub-group. That is, the point cloud sub-group uses uniform prediction attribute information, and the uniform prediction attribute information is prediction attribute information of the target point in the point cloud sub-group. For example, the target point cloud group includes five points: a point A, a point B, a point C, a point D, and a point E. The point A and the point B belong to a point cloud sub-group 1, the point C and the point D belong to a point cloud sub-group 2, and the point E belongs to a point cloud sub-group 3. The point A, the point C, and the point E may be determined as target points, and prediction attribute information of the point A, the point C, and the point E may be determined, the prediction attribute information of the point A is determined as prediction attribute information of the point B, and the prediction attribute information of the point C is determined as prediction attribute information of the point D.

In addition to the foregoing sub-step s11 and sub-step s12, a process of performing attribute prediction on each point in the target point cloud group according to the attribute decoding mode of the target point cloud group, to obtain prediction attribute information of each point in the target point cloud group may further include: a process of separately determining the prediction attribute information of each point in the target point cloud group and determining prediction attribute information of any point in the target point cloud group is the same as a manner of determining the prediction attribute information of the target point in the foregoing sub-step s11. For details, refer to the foregoing sub-step s11. Details are not described herein again.

In addition, when the attribute decoding mode of the target point cloud group is the intra-group attribute decoding mode, the attribute decoding mode may include multiple intra-group attribute decoding modes, and a quantity of points included in the target point cloud group may be counted. If the quantity of points is greater than a second quantity threshold, it may be determined that the attribute decoding mode of the target point cloud group is a first intra-group attribute decoding mode. If the quantity of points is less than or equal to the second quantity threshold, it may be determined that the attribute decoding mode of the target point cloud group is a second intra-group attribute decoding mode, and the first intra-group attribute decoding mode is different from the second intra-group attribute decoding mode. For example, if the quantity of points is greater than the second quantity threshold, the prediction attribute information of each point in the target point cloud group may be separately determined. If the quantity of points is less than or equal to the second quantity threshold, the prediction attribute information of each point in the target point cloud group may be determined by using any one of the intra-group attribute decoding modes in the foregoing (1) to (4).

S504. Perform attribute decoding processing on each point in the target point cloud group to obtain reconstruction residual information of each point in the target point cloud group.

S505. Perform attribute decoding processing on each point in the target point cloud group to obtain a reconstruction transform coefficient of each point in the target point cloud group.

S506. Perform inverse transform processing on the reconstruction transform coefficient of each point in the target point cloud group to obtain the reconstruction residual information of each point in the target point cloud group.

S507. Determine reconstruction attribute information of each point in the target point cloud group according to the prediction attribute information and the reconstruction residual information of each point in the target point cloud group.

If the attribute prediction decoding manner is used in this embodiment of this disclosure, the point cloud decoding method in this embodiment of this disclosure may include step S501 to step S504 and step S507. If the attribute predicting transform decoding manner is used in this embodiment of this disclosure, the point cloud decoding method in this embodiment of this disclosure may include step S501 to step S503 and step S505 to step S507. If the attribute decoding manner of performing transform determining is used in this embodiment of this disclosure, when the target point cloud group meets the transform condition, the point cloud decoding method in this embodiment of this disclosure may include step S501 to step S503 and step S505 to step S507. When the target point cloud group does not meet the transform condition, the point cloud decoding method in this embodiment of this disclosure may include step S501 to step S504 and step S507. In addition, an execution process of step S507 in this embodiment of this disclosure is the same as an execution process of step S305 in the embodiment shown in FIG. 3. For details, refer to the execution process of step S305 in the embodiment shown in FIG. 3. Details are not described herein again.

In this embodiment of this disclosure, the attribute decoding mode of the target point cloud group may be determined based on the geometric relationship between the target point cloud group and the associated point cloud group of the target point cloud group. In this way, an attribute decoding mode suitable for performing attribute prediction on the target point cloud group may be determined, thereby improving accuracy and prediction efficiency of performing attribute prediction on each point in the target point cloud group.

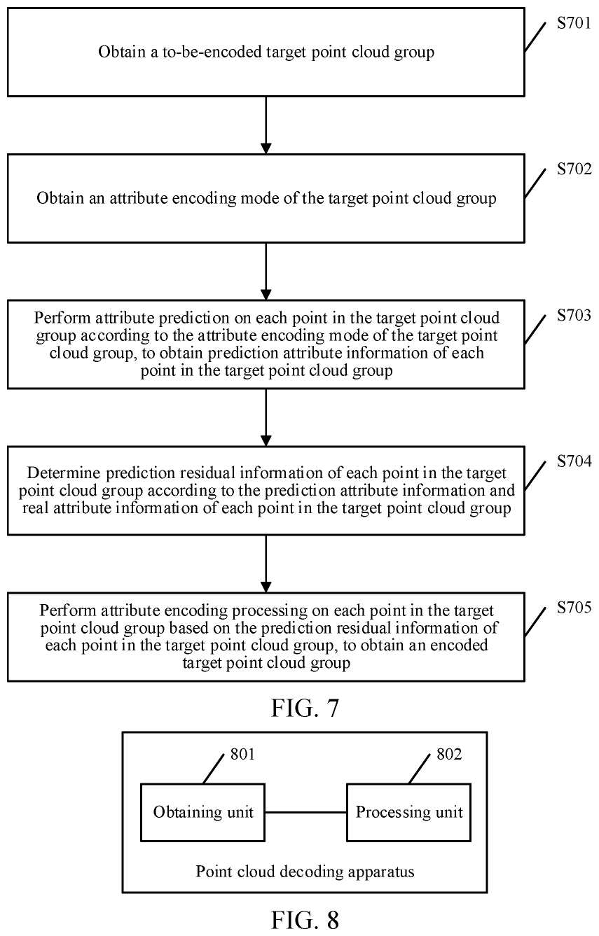

An embodiment of this disclosure provides a point cloud encoding method. The point cloud encoding method mainly describes an overall process of point cloud attribute encoding, a grouping manner of point cloud data, a determining process of an attribute encoding mode of a target point cloud group, an attribute prediction process of the target point cloud group, and a transform determining in point cloud attribute encoding. The point cloud encoding method may be performed by the encoding device 201 in the point cloud attribute encoding and decoding system 20. As shown in FIG. 7, the point cloud encoding method may include the following steps S701 to S705:

S701. Obtain a to-be-encoded target point cloud group.

It may be understood from the foregoing content that the point cloud attribute encoding solution provided in this embodiment of this disclosure may be obtained by encoding to-be-encoded point cloud data by using a point cloud group as an encoding unit. Therefore, grouping processing is performed on the to-be-encoded point cloud data, and the to-be-encoded target point cloud group may be any point cloud group obtained by performing grouping processing on the to-be-encoded point cloud data.

A manner of performing grouping processing on the to-be-encoded point cloud data is described herein. The performing grouping processing on the to-be-encoded point cloud data may include but is not limited to any one of the following:

(1) Point cloud grouping manner of repeated point truncation. In an example, a process in which each to-be-encoded point in the to-be-encoded point cloud data is encoded sequentially according to an encoding sequence of the to-be-encoded point in the to-be-encoded point cloud data may include: performing grouping processing on one or more preceding points of a current to-be-encoded point according to a specified rule in a case that the current to-be-encoded point is a repeated point. The performing grouping processing on one or more preceding points of a current to-be-encoded point according to a specified rule may include any one of the following two cases: In a first case, if there is no repeated point in the preceding point of the current to-be-encoded point, that is, the current to-be-encoded point is the first repeated point in the to-be-encoded point cloud data, grouping processing may be performed on the one or more preceding points of the current to-be-encoded point according to the specified rule. In a second case, if one or more repeated points exist in the preceding point of the current to-be-encoded point, that is, the current to-be-encoded point is not the first repeated point in the to-be-encoded point cloud data, grouping processing may be performed on one or more preceding points of the current to-be-encoded point located between the current to-be-encoded point and a previous repeated point of the current to-be-encoded point.

The preceding point of the current to-be-encoded point may be a point whose encoding sequence is before that of the current to-be-encoded point. That the current to-be-encoded point is a repeated point may mean that geometric information of the current to-be-encoded point is the same as geometric information of any preceding point of the current to-be-encoded point. That geometric information of the current to-be-encoded point is the same as geometric information of the preceding point may mean that: Three-dimensional coordinates of the current to-be-encoded point are the same as three-dimensional coordinates of the preceding point, that is, the current to-be-encoded point is overlapped with the preceding point in three-dimensional space. The specified rule may refer to a grouping rule, and the point cloud grouping manner does not limit the grouping rule. For example, the grouping rule may include but is not limited to any one of the following: setting a grouping quantity threshold of each point cloud group (the grouping quantity threshold refers to a maximum quantity of points that each point cloud group allows to accommodate); grouping points arranged at odd-number position into one point cloud group, and grouping points arranged at even-number positions into one point cloud group; and so on.

(2) Quantitative point cloud grouping manner in which a repeated point is not counted in a group. In an example, a process in which each to-be-encoded point in the to-be-encoded point cloud data is encoded sequentially according to an encoding sequence of the to-be-encoded point in the to-be-encoded point cloud data may include: skipping a current to-be-encoded point in a case that the current to-be-encoded point is a repeated point, adding a non-repeated point whose encoding sequence is after that of the current to-be-encoded point to a current point cloud group until a quantity of to-be-encoded points included in the current point cloud group reaches a grouping quantity threshold.

The preceding point of the current to-be-encoded point may be a point whose encoding sequence is before that of the current to-be-encoded point. That the current to-be-encoded point is a repeated point may mean that geometric information of the current to-be-encoded point is the same as geometric information of any preceding point of the current to-be-encoded point. That geometric information of the current to-be-encoded point is the same as geometric information of the preceding point may mean that: Three-dimensional coordinates of the current to-be-encoded point are the same as three-dimensional coordinates of the preceding point, that is, the current to-be-encoded point is overlapped with the preceding point in three-dimensional space. That any to-be-encoded point is a non-repeated point may mean that geometric information of the to-be-encoded point is different from geometric information of all preceding points of the to-be-encoded point. The grouping quantity threshold may refer to a maximum quantity of points that the current point cloud group allows to accommodate.

(3) Quantitative point cloud grouping manner in which a repeated point is counted in a group. In an example, a process in which each to-be-encoded point in the to-be-encoded point cloud data is encoded sequentially according to an encoding sequence of the to-be-encoded point in the to-be-encoded point cloud data may include: adding a current to-be-encoded point to a current point cloud group in a case that the current to-be-encoded point is a repeated point; and adding, in a case that a quantity of points included in the current point cloud group does not reach a grouping quantity threshold, a to-be-encoded point whose encoding sequence is after that of the current to-be-encoded point to the current point cloud group until the quantity of points included in the current point cloud group reaches the grouping quantity threshold.

The preceding point of the current to-be-encoded point may be a point whose encoding sequence is before that of the current to-be-encoded point. That the current to-be-encoded point is a repeated point may mean that geometric information of the current to-be-encoded point is the same as geometric information of any preceding point of the current to-be-encoded point. That geometric information of the current to-be-encoded point is the same as geometric information of the preceding point may mean that: Three-dimensional coordinates of the current to-be-encoded point are the same as three-dimensional coordinates of the preceding point, that is, the current to-be-encoded point is overlapped with the preceding point in three-dimensional space. The grouping quantity threshold may refer to a maximum quantity of points that the current point cloud group allows to accommodate.

(4) Point cloud grouping manner in which a repeated point is counted in a group. In an example, a process in which each to-be-encoded point in the to-be-encoded point cloud data is encoded sequentially according to an encoding sequence of the to-be-encoded point in the to-be-encoded point cloud data may include: performing, in a case that a current to-be-encoded point is a repeated point, grouping processing on the repeated point. The preceding point of the current to-be-encoded point may be a point whose encoding sequence is before that of the current to-be-encoded point. That the current to-be-encoded point is a repeated point may mean that geometric information of the current to-be-encoded point is the same as geometric information of any preceding point of the current to-be-encoded point. That geometric information of the current to-be-encoded point is the same as geometric information of the preceding point may mean that: Three-dimensional coordinates of the current to-be-encoded point are the same as three-dimensional coordinates of the preceding point, that is, the current to-be-encoded point is overlapped with the preceding point in three-dimensional space. That is, a repeated point is counted in a group in the point cloud grouping manner, but the point cloud grouping manner does not limit the grouping rule. For example, the grouping rule may include but is not limited to any one of the following: setting a grouping quantity threshold of each point cloud group (the grouping quantity threshold refers to a maximum quantity of points that each point cloud group allows to accommodate), that is, the solution described in (3) above; grouping points arranged at odd-number position into one point cloud group, and grouping points arranged at even-number positions into one point cloud group; and so on.

(5) Point cloud grouping manner of determining a quantity of repeated points. In an example, a process in which each to-be-encoded point in the to-be-encoded point cloud data is encoded sequentially according to an encoding sequence of the to-be-encoded point in the to-be-encoded point cloud data may include: skipping performing grouping processing on a current to-be-encoded point in a case that the current to-be-encoded point is a repeated point, and a quantity of counted repeated points is greater than a first quantity threshold; and performing grouping processing on the current to-be-encoded point in a case that the current to-be-encoded point is a repeated point, but the quantity of counted repeated points is less than or equal to the first quantity threshold.

The preceding point of the current to-be-encoded point may be a point whose encoding sequence is before that of the current to-be-encoded point. That the current to-be-encoded point is a repeated point may mean that geometric information of the current to-be-encoded point is the same as geometric information of any preceding point of the current to-be-encoded point. That geometric information of the current to-be-encoded point is the same as geometric information of the preceding point may mean that: Three-dimensional coordinates of the current to-be-encoded point are the same as three-dimensional coordinates of the preceding point, that is, the current to-be-encoded point is overlapped with the preceding point in three-dimensional space. The quantity of counted repeated points may refer to: a quantity obtained after a quantity of repeated points existing in preceding points of the current to-be-encoded point plus 1 (that is, plus the current to-be-encoded point).

That is, in the point cloud grouping manner, when the current to-be-encoded point is a repeated point and the quantity of counted repeated points is greater than the first quantity threshold, the current to-be-encoded point may not be included in the point cloud group; and when the current to-be-encoded point is a repeated point and the quantity of counted repeated points is less than or equal to the first quantity threshold, the current to-be-encoded point may be included in the point cloud group. In addition, the point cloud grouping manner does not limit the grouping rule. For example, the grouping rule may include but is not limited to any one of the following: setting a grouping quantity threshold of each point cloud group (the grouping quantity threshold refers to a maximum quantity of points that each point cloud group allows to accommodate); grouping points arranged at odd-number position into one point cloud group, and grouping points arranged at even-number positions into one point cloud group; and so on.

(6) Point cloud grouping manner based on similar sorting codes. In an example, a process in which each to-be-encoded point in the to-be-encoded point cloud data is encoded sequentially according to an encoding sequence of the to-be-encoded point in the to-be-encoded point cloud data may include: first, re-sorting may be performed on each to-be-encoded point (this step may be ignored for each re-sorted to-be-encoded point); and then, points with the same last L bits in the sorting codes may be grouped into one point cloud group.

(7) Point cloud grouping manner based on sorting code shift. In an example, a process in which each to-be-encoded point in the to-be-encoded point cloud data is encoded sequentially according to an encoding sequence of the to-be-encoded point in the to-be-encoded point cloud data may include: re-sorting each to-be-encoded point (this step may be ignored for a re-sorted to-be-encoded point); performing target shift bit-based processing (for example, rightward shift processing) on a sorting code (for example, may be the foregoing Hilbert code) of each to-be-encoded point; grouping to-be-encoded points having the same shift-processed sorting code into one point cloud block, where a repeated point is not counted in the point cloud block; for any point cloud block, if a quantity of to-be-encoded points included in the point cloud block is less than or equal to the grouping quantity threshold, the point cloud block may be determined as one point cloud group; and if the quantity of to-be-encoded points included in the point cloud block is greater than the grouping quantity threshold, grouping processing may be performed on the point cloud block according to the grouping quantity threshold.

The point cloud grouping manners described in the foregoing (1) to (7) are similar to those in the decoding phase. For details, refer to a specific description of the decoding phase. For a point cloud grouping manner in which a repeated point is not counted in a point cloud group, similar points may be more centralized, and encoding of duplicate information may be reduced in an encoding process, thereby improving encoding efficiency. For a point cloud grouping manner in which a repeated point is counted in a point cloud group, a quantity of repeated points existing in to-be-encoded point cloud data is generally relatively small (for example, the foregoing mentioned quantity of counted repeated points is less than or equal to the first quantity threshold), which has little impact on encoding efficiency.

S702. Obtain an attribute encoding mode of the target point cloud group.

The target point cloud group may include one or more to-be-encoded points. After the to-be-encoded target point cloud group is obtained, the attribute encoding mode of the target point cloud group may be obtained. The attribute encoding mode is a method or a policy used for predicting a prediction attribute value of each point in the target point cloud group in an encoding phase of the target point cloud group. The attribute encoding mode may include an intra-group attribute encoding mode or an inter-group attribute encoding mode. The intra-group attribute encoding mode may refer to: determining, according to prediction attribute information of a target point in the target point cloud group, an attribute encoding mode of a prediction attribute information of a point other than the target point in the target point cloud group, where a quantity of target points may be one or more; or may refer to: separately determining an attribute encoding mode of prediction attribute information of each point in the target point cloud group. The inter-group attribute encoding mode may refer to: determining an attribute encoding mode of prediction attribute information of each point in the target point cloud group according to reconstruction attribute information of the point in the associated point cloud group of the target point cloud group.

Attribute encoding modes of any two point cloud groups obtained by performing grouping processing on the to-be-encoded point cloud data may be the same or different. For example, the target point cloud group is any point cloud group obtained by performing grouping processing on to-be-encoded point cloud data; grouping processing may be performed on the to-be-encoded point cloud data to further obtain a first point cloud group, where the first point cloud group is any point cloud group other than the target point cloud group, that is, the target point cloud group and the first point cloud group are any two point cloud groups obtained by performing grouping processing on the to-be-encoded point cloud data; an attribute encoding mode of the first point cloud group is different from the attribute encoding mode of the target point cloud group; or an attribute encoding mode of the first point cloud group is the same as the attribute encoding mode of the target point cloud group.

The following provides two manners of determining the attribute encoding mode of the target point cloud group:

(1) Rate distortion optimization (RDO) manner. The obtaining an attribute encoding mode of the target point cloud group may include: first, performing attribute prediction on each point in the target point cloud group according to the inter-group attribute encoding mode, to obtain prediction attribute information of each point in the target point cloud group in the inter-group attribute encoding mode; performing encoding processing on the prediction attribute information of each point in the target point cloud group in the inter-group attribute encoding mode to obtain first encoding information; then, performing attribute prediction on each point in the target point cloud group according to the intra-group attribute encoding mode, to obtain prediction attribute information of each point in the target point cloud group in the intra-group attribute encoding mode; performing encoding processing on the prediction attribute information of each point in the target point cloud group in the intra-group attribute encoding mode to obtain second encoding information; determining that the attribute encoding mode of the target point cloud group is the intra-group attribute encoding mode in a case that the first encoding information is greater than or equal to the second encoding information; and determining that the attribute encoding mode of the target point cloud group is the inter-group attribute encoding mode in a case that the first encoding information is less than the second encoding information.

The first encoding information may be used for measuring an encoding effect of encoding the prediction attribute information of each point in the target point cloud group in the inter-group attribute encoding mode, and smaller first encoding information indicates a better encoding effect. The second encoding information may be used for measuring an encoding effect of encoding the prediction attribute information of each point in the target point cloud group in the intra-group attribute encoding mode. Smaller second encoding information indicates a better encoding effect. That is, in the RDO manner, the prediction attribute information of each point in the target point cloud group in the intra-group attribute encoding mode and the inter-group attribute encoding mode is directly encoded, and an attribute encoding mode with a good encoding effect is determined as the attribute encoding mode of the target point cloud group.

(2) Inter-group similarity manner. The obtaining an attribute encoding mode of the target point cloud group may include: determining M associated point cloud groups of the target point cloud group from point cloud groups obtained by performing grouping processing on to-be-decoded point cloud data, the M associated point cloud groups being M neighboring point cloud groups before the target point cloud group in the point cloud groups obtained by performing grouping processing on the to-be-decoded point cloud data and whose decoding sequences are before that of the target point cloud group, and M being a positive integer; calculating inter-group similarity between the target point cloud group and the M associated point cloud groups; determining that the attribute encoding mode of the target point cloud group is the inter-group attribute encoding mode in a case that the inter-group similarity is greater than a similarity threshold; and determining that the attribute encoding mode of the target point cloud group is the intra-group attribute encoding mode in a case that the inter-group similarity is less than or equal to the similarity threshold.

The inter-group similarity may include any one or two of the following: inter-group attribute similarity or inter-group geometric similarity. The inter-group attribute similarity may be obtained by means of calculation according to real attribute information of each point in the target point cloud group and real attribute information of each point in the M associated point cloud groups. For example, a difference between the real attribute information of each point in the target point cloud group and the real attribute information of each point in the M associated point cloud groups may be calculated, and then a difference sum of the points in the target point cloud group may be obtained, and a reciprocal obtained after the difference sum is determined as the inter-group attribute similarity. A larger value of the inter-group attribute similarity indicates higher similarity between the target point cloud group and the M associated point cloud groups. The inter-group geometric similarity may be obtained by means of calculation according to the geometric information of each point in the target point cloud group and geometric information of each point in the M associated point cloud groups. For example, a distance between each point in the target point cloud group and each point in the M associated point cloud groups may be calculated according to the geometric information of each point in the target point cloud group and the geometric information of each point in the M associated point cloud groups. Then, a distance sum of the points in the target point cloud group may be calculated, and a reciprocal obtained after the distance sum is determined as inter-group geometric similarity. A larger value of the inter-group geometric similarity indicates higher similarity between the target point cloud group and the M associated point cloud groups.

That is, in the inter-group similarity manner, the attribute encoding mode of the target point cloud group is selected by using the similarity between the target point cloud group and the associated point cloud group of the target point cloud group. When the similarity between the target point cloud group and the associated point cloud group is high, the inter-group attribute encoding mode may be used as the attribute encoding mode of the target point cloud group. When the similarity between the target point cloud group and the associated point cloud group is low, the inter-group attribute encoding mode may be used as the attribute encoding mode of the target point cloud group.

S703. Perform attribute prediction on each point in the target point cloud group according to the attribute encoding mode of the target point cloud group, to obtain prediction attribute information of each point in the target point cloud group.

When the attribute encoding mode of the target point cloud group is the inter-group attribute encoding mode, a process in which attribute prediction is performed on each point in the target point cloud group according to the attribute encoding mode of the target point cloud group to obtain the prediction attribute information of each point in the target point cloud group may specifically include any one of the following two types:

(1) determining M associated point cloud groups of the target point cloud group from point cloud groups obtained by performing grouping processing on to-be-encoded point cloud data, the M associated point cloud groups being M neighboring point cloud groups before the target point cloud group in the point cloud groups obtained by performing grouping processing on the to-be-encoded point cloud data and whose encoding sequences are before that of the target point cloud group, and M being a positive integer; and then, determining an average value of reconstruction attribute information of each point in the M associated point cloud groups as the prediction attribute information of each point in the target point cloud group. That is, a uniform prediction attribute value is used for each point in the target point cloud group, and the uniform prediction attribute value is an average value of the reconstruction attribute information of each point in the M associated point cloud groups. Reconstruction attribute information of any point in the M associated point cloud groups is determined according to prediction attribute information of the point and reconstruction residual information of the point; and herein, the reconstruction attribute information of each point in the M associated point cloud groups is used for determining the prediction attribute information of each point in the target point cloud group, instead of using the real attribute information of each point in the M associated point cloud groups to determine the prediction attribute information of each point in the target point cloud group. This processing is to ensure consistency of the encoding and decoding process, because the real attribute information of each point in the M associated point cloud groups cannot be obtained in the decoding process.

(2) determining M associated point cloud groups of the target point cloud group from point cloud groups obtained by performing grouping processing on to-be-encoded point cloud data, the M associated point cloud groups being M neighboring point cloud groups before the target point cloud group in the point cloud groups obtained by performing grouping processing on the to-be-encoded point cloud data and whose encoding sequences are before that of the target point cloud group, and M being a positive integer; and then, determining an associated point of each point in the target point cloud group from the M associated point cloud groups; and determining the prediction attribute information of each point in the target point cloud group according to reconstruction attribute information of the associated point of each point in the target point cloud group. That is, prediction attribute information of any point in the target point cloud group is determined according to reconstruction attribute information of an associated point of the point.

An associated point of any point in the target point cloud group may be one or more points that are in the M associated point cloud groups and that have a close distance from the point. When any point in the target point cloud group (for example, may be represented as an ith point, and i is a positive integer) is a point that is in the M associated point cloud groups and that has a close distance from the any point, prediction attribute information of the ith point is equal to reconstruction attribute information of the associated point. When any point in the target point cloud group (for example, may be represented as an ith point, and i is a positive integer) is multiple points that are in the M associated point cloud groups and that are close to the ith point, prediction attribute information of the ith point is equal to an average value or a weighted average value of reconstruction attribute information of the multiple associated points, and a weight of any associated point may be determined according to a distance between the associated point and the ith point, for example, may be a reciprocal of the distance between the associated point and the ith point.

When the attribute encoding mode of the target point cloud group is the intra-group attribute encoding mode, the process in which attribute prediction is performed on each point in the target point cloud group according to the attribute encoding mode of the target point cloud group to obtain the prediction attribute information of each point in the target point cloud group may include the following sub-step s11 and sub-step s12:

s11. Determine prediction attribute information of a target point in the target point cloud group.

In an implementation, the target point may be any one or more points in the target point cloud group. For example, the target point may be a point in the target point cloud group that is ranked first, or may be a point in the target point cloud group that is ranked last, or may be a point in the target point cloud group that is ranked first and a point in the target point cloud group that is ranked last.

In another implementation, grouping processing may be performed on the target point cloud group to obtain P point cloud sub-groups, where P is an integer greater than or equal to 2; and one point may be selected from each point cloud sub-group of the P point cloud sub-groups as a target point. That is, each point cloud sub-group of the P point cloud sub-groups includes one target point. For example, the target point of each point cloud sub-group may be a point that is ranked first in the point cloud sub-group.

In the foregoing two implementations, a manner of determining the prediction attribute information of the target point may include any one of the following two cases:

(1) determining reconstruction attribute information of a neighboring point whose encoding sequence is before that of the target point in the target point cloud group as the prediction attribute information of the target point. For example, the target point in the target point cloud group may be represented as an ith point, prediction attribute information of the ith point may be determined according to reconstruction attribute information of an (i−1)th point, and i is an integer greater than 1.

(2) determining Q neighboring points of the target point in a point cloud group obtained by performing grouping processing on to-be-decoded point cloud data, Q being a positive integer; determining a geometric relationship between the Q neighboring points and the target point; and determining a prediction attribute value of the target point according to the geometric relationship between the Q neighboring points and the target point and reconstruction attribute information of the Q neighboring points; the Q neighboring points being Q points that are in the point cloud group obtained by performing grouping processing on the to-be-encoded point cloud data and that are geometrically close to the target point.

s12. Determine the prediction attribute information of each point in the target point cloud group according to the prediction attribute information of the target point.

A manner of determining the prediction attribute information of each point in the target point cloud group according to the prediction attribute information of the target point may include any one of the following four cases:

(1) determining the prediction attribute information of the target point as the prediction attribute information of each point in the target point cloud group in a case that the target point is any point in the target point cloud group, which may specifically include: determining the prediction attribute information of each point in the target point cloud group according to the prediction attribute information of the target point. That is, each point in the target point cloud group uses uniform prediction attribute information, and the uniform prediction attribute information is the prediction attribute information of the target point.

(2) determining the prediction attribute information of the target point as the prediction attribute information of each point in the target point cloud group in a case that the target point is any point in the target point cloud group, which may specifically include: determining a geometric relationship between another point in the target point cloud group except the target point and the target point; and determining prediction attribute information of the another point according to the geometric relationship between the another point and the target point and the prediction attribute information of the target point.

The geometric relationship between the another point and the target point may refer to a distance between the another point and the target point. A process of determining prediction attribute information of the another point according to the geometric relationship between the another point and the target point and the prediction attribute information of the target point may include: determining a weight of each another point according to a distance between the another point and the target point, where the weight of any another point may be a reciprocal of the distance between the another point and the target point; and weighted summation is performed on prediction attribute information of each another point according to the weight of each another point, to obtain the prediction attribute information of the target point.

(3) determining the prediction attribute information of the target point as the prediction attribute information of each point in the target point cloud group in a case that the target point is any multiple points in the target point cloud group, which may specifically include: determining an average value of the prediction attribute information of the multiple target points as the prediction attribute information of each point in the target point cloud group. That is, each point in the target point cloud group uses uniform prediction attribute information, and the uniform prediction attribute information is an average value of the prediction attribute information of the multiple target points.

(4) When a target point is included in each point cloud sub-group in P point cloud sub-groups obtained by performing grouping processing on the target point cloud group, prediction attribute information of the target point in each point cloud sub-group in the P point cloud sub-groups may be determined as prediction attribute information of each point in the corresponding point cloud sub-group. That is, the point cloud sub-group uses uniform prediction attribute information, and the uniform prediction attribute information is prediction attribute information of the target point in the point cloud sub-group.

In addition to the foregoing sub-step s11 and sub-step s12, a process of performing attribute prediction on each point in the target point cloud group according to the attribute encoding mode of the target point cloud group, to obtain prediction attribute information of each point in the target point cloud group may further include: a process of separately determining the prediction attribute information of each point in the target point cloud group and determining prediction attribute information of any point in the target point cloud group is the same as a manner of determining the prediction attribute information of the target point in the foregoing sub-step s11. For details, refer to the foregoing sub-step s11. Details are not described herein again.

In addition, when the attribute encoding mode of the target point cloud group is the intra-group attribute encoding mode, the attribute encoding mode may include multiple intra-group attribute encoding modes, and a quantity of points included in the target point cloud group may be counted. If the quantity of points is greater than a second quantity threshold, it may be determined that the attribute encoding mode of the target point cloud group is a first intra-group attribute encoding mode. If the quantity of points is less than or equal to the second quantity threshold, it may be determined that the attribute encoding mode of the target point cloud group is a second intra-group attribute encoding mode, and the first intra-group attribute encoding mode is different from the second intra-group attribute encoding mode. For example, if the quantity of points is greater than the second quantity threshold, the prediction attribute information of each point in the target point cloud group may be separately determined. If the quantity of points is less than or equal to the second quantity threshold, the prediction attribute information of each point in the target point cloud group may be determined by using any one of the intra-group attribute encoding modes in the foregoing (1) to (4).

S704. Determine prediction residual information of each point in the target point cloud group according to the prediction attribute information and real attribute information of each point in the target point cloud group.

After the prediction attribute information and the real attribute information of each point in the target point cloud group are determined, the prediction residual information of each point in the target point cloud group may be determined according to the prediction attribute information and the real attribute information of each point in the target point cloud group. Prediction residual information of any point in the target point cloud group may be equal to a difference between real attribute information of the point and prediction attribute information of the point.

S705. Perform attribute encoding processing on each point in the target point cloud group based on the prediction residual information of each point in the target point cloud group, to obtain an encoded target point cloud group.

The performing attribute encoding processing on each point in the target point cloud group based on the prediction residual information of each point in the target point cloud group, to obtain an encoded target point cloud group may include any one of the following cases:

(1) Attribute prediction encoding. In the attribute prediction encoding manner, the performing attribute encoding processing on each point in the target point cloud group based on the prediction residual information of each point in the target point cloud group, to obtain an encoded target point cloud group may include: performing attribute encoding processing on prediction residual information of each point in the target point cloud group to obtain an encoded target point cloud group, that is, to obtain an attribute code of each point in the target point cloud group. The performing attribute encoding processing on the prediction residual information of each point in the target point cloud group to obtain the encoded target point cloud group may specifically include: performing quantization processing on the prediction residual information of each point in the target point cloud group, to obtain a residual quantization value of each point in the target point cloud group; and performing encoding processing (for example, entropy encoding processing) on the residual quantization value of each point in the target point cloud group, to obtain an attribute code of each point in the target point cloud group.

(2) Attribute predicting transform encoding. In the attribute predicting transform encoding manner, the performing attribute encoding processing on each point in the target point cloud group based on the prediction residual information of each point in the target point cloud group, to obtain an encoded target point cloud group may include: performing transform processing (that is, the foregoing second transform processing) on the prediction residual information of each point in the target point cloud group, to obtain a residual transform coefficient of each point in the target point cloud group; and performing attribute encoding processing on the residual transform coefficient of each point in the target point cloud group to obtain an encoded target point cloud group, that is, to obtain the attribute code of each point in the target point cloud group. The performing attribute encoding processing on the residual transform coefficient of each point in the target point cloud group to obtain an encoded target point cloud group may specifically include: performing quantization processing on the residual transform coefficient of each point in the target point cloud group, to obtain a residual quantization value of each point in the target point cloud group; and performing encoding processing (for example, entropy encoding processing) on the residual quantization value of each point in the target point cloud group, to obtain an attribute code of each point in the target point cloud group. The second transform processing may be, for example, performing the foregoing DCT processing on the prediction residual information of each point in the target point cloud group.

(3) Attribute code for transform determining. In the foregoing (1), attribute prediction encoding processing may be directly performed on the target point cloud group to obtain the attribute code of each point in the target point cloud group. In the foregoing (2), attribute predicting transform encoding processing may be directly performed on the target point cloud group to obtain the attribute code of each point in the target point cloud group. Based on this, an attribute code for transform determining is proposed, that is, a transform determining process for the target point cloud group is added. The attribute prediction encoding in the foregoing (1) needs to be used for determining the target point cloud group, or the attribute predicting transform encoding in the foregoing (2) needs to be used. In an example, transform determining may be performed on the target point cloud group. If the target point cloud group meets a transform condition, transform processing (that is, the foregoing second transform processing) may be performed on the prediction residual information of each point in the target point cloud group, to obtain a residual transform coefficient of each point in the target point cloud group; attribute encoding processing is performed on the residual transform coefficient of each point in the target point cloud group to obtain an encoded target point cloud group, that is, to obtain the attribute code of each point in the target point cloud group, that is, the foregoing (2); and if the target point cloud group does not meet the transform condition, attribute encoding processing may be performed on the prediction residual information of each point in the target point cloud group to obtain the encoded target point cloud group, that is, to obtain the attribute code of each point in the target point cloud group, that is, the foregoing (1).

That the target point cloud group meets the transform condition may include any one of the following: A quantity of points included in the target point cloud group meets a quantity condition. For example, the quantity of points included in the target point cloud group is greater than or equal to a transform quantity threshold, and the quantity of points included in the target point cloud group is an odd number (or an even number). Alternatively, distribution of the prediction residual information of each point in the target point cloud group meets a distribution condition, for example, a difference between maximum prediction residual information and minimum prediction residual information in the prediction residual information of each point in the target point cloud group is less than or equal to a distribution threshold, and a variance of the prediction residual information of each point in the target point cloud group is less than or equal to a variance threshold.

That the target point cloud group does not meet the transform condition may include any one of the following: The quantity of points included in the target point cloud group does not meet the quantity condition, where the quantity condition may be whether the quantity of points included in the target point cloud group is greater than or equal to the transform quantity threshold, whether the quantity of points included in the target point cloud group is an odd number (or an even number), or the like. For example, a case in which the quantity of points included in a target point cloud group does not meet the quantity condition may be as follows: The quantity of points included in the target point cloud group is less than the transform quantity threshold, the quantity of points included in the target point cloud group is an even number (or an odd number), and the like. Alternatively, distribution of the prediction residual information of each point in the target point cloud group does not meet the distribution condition, where the distribution condition may be a case in which the difference between the maximum reconstruction residual information and the minimum reconstruction residual information in the reconstruction residual information of each point in the target point cloud group is less than or equal to the distribution threshold, and the variance of the reconstruction residual information of each point in the target point cloud group is less than or equal to the variance threshold. For example, that distribution of the reconstruction residual information of each point in the target point cloud group does not meet the distribution condition may be as follows: The difference between the maximum prediction residual information and the minimum prediction residual information in the prediction residual information of each point in the target point cloud group is greater than the distribution threshold, the variance of the prediction residual information of each point in the target point cloud group is greater than the variance threshold, and the like.

In this embodiment of this disclosure, in a process of performing grouping processing on the to-be-encoded point cloud data, a repeated point may not be counted in a group. In this way, encoding of repetition information can be reduced, so that similar points are more centralized, and encoding efficiency is improved. In addition, attribute encoding modes of any two point cloud groups obtained by performing grouping processing on the to-be-encoded point cloud data may be different. By designing differentiated attribute encoding modes in different point cloud groups, accuracy of attribute prediction performed on the point cloud group can be ensured. In addition, when the target point cloud group meets a transform condition, transform processing may be performed on the prediction residual information of each point in the target point cloud group. In this way, distribution of the prediction residual information of each point in the target point cloud group may be changed, and the residual transform coefficients are concentrated in a low-frequency direction, so as to reduce an effective data amount, thereby facilitating encoding and improving encoding efficiency. In addition, the attribute prediction mode of the target point cloud group may be determined based on a geometric relationship between the target point cloud group and an associated point cloud group of the target point cloud group, or the attribute prediction mode of the target point cloud group may be determined based on encoding effects of the target point cloud group in different attribute prediction modes. In this way, an attribute encoding mode that is suitable for performing attribute prediction on the target point cloud group may be determined, thereby improving accuracy of performing attribute prediction on each point in the target point cloud group.

The foregoing describes in more detail the methods in the embodiments of this disclosure. To better implement the foregoing solutions in the embodiments of this disclosure, correspondingly, the following provides apparatuses in the embodiments of this disclosure.

Referring to FIG. 8, FIG. 8 is a schematic structural diagram of a point cloud decoding apparatus according to an embodiment of this disclosure. The point cloud decoding apparatus may be disposed in a computer device provided in this embodiment of this disclosure, and the computer device may be the decoding device mentioned in the foregoing method embodiment. In some embodiments, the point cloud decoding apparatus may be a computer program (including program code) running in a computer device, and the point cloud decoding apparatus may be configured to perform corresponding steps in the method embodiment shown in FIG. 3 or FIG. 5. Referring to FIG. 8, the point cloud decoding apparatus may include an obtaining unit 801 and a processing unit 802.

The obtaining unit 801 is configured to obtain a to-be-decoded target point cloud group and an attribute decoding mode of the target point cloud group, the target point cloud group including at least one to-be-decoded point; and

The processing unit 802 is configured to perform attribute prediction on each point in the target point cloud group according to the attribute decoding mode of the target point cloud group, to obtain prediction attribute information of each point in the target point cloud group; perform attribute decoding processing on each point in the target point cloud group to obtain reconstruction residual information of each point in the target point cloud group; and determine reconstruction attribute information of each point in the target point cloud group according to the prediction attribute information and the reconstruction residual information of each point in the target point cloud group.

In an implementation, the processing unit 802 is specifically configured to perform the following steps when performing attribute decoding processing on each point in the target point cloud group to obtain reconstruction residual information of each point in the target point cloud group:
performing attribute decoding processing on each point in the target point cloud group to obtain reconstruction residual information of each point in the target point cloud group;
or performing attribute decoding processing on each point in the target point cloud group to obtain a reconstruction transform coefficient of each point in the target point cloud group, and performing inverse transform processing on the reconstruction transform coefficient of each point in the target point cloud group to obtain the reconstruction residual information of each point in the target point cloud group.

In an implementation, the processing unit 802 is further configured to perform the following steps:
performing transform determining on the target point cloud group; and triggering, in a case that the target point cloud group meets a transform condition, the operation of performing inverse transform processing on the reconstruction transform coefficient of each point in the target point cloud group to obtain the reconstruction residual information of each point in the target point cloud group; and that the target point cloud group meets the transform condition including any one of the following: a quantity of points included in the target point cloud group meets a quantity condition, or distribution of the reconstruction residual information of each point in the target point cloud group meets a distribution condition.

In an implementation, the target point cloud group is any point cloud group obtained by performing grouping processing on to-be-decoded point cloud data; performing grouping processing on the to-be-decoded point cloud data further obtains a first point cloud group, the first point cloud group being any point cloud group other than the target point cloud group; an attribute decoding mode of the first point cloud group is different from the attribute decoding mode of the target point cloud group; or an attribute decoding mode of the first point cloud group is the same as the attribute decoding mode of the target point cloud group.

In an implementation, each to-be-decoded point in the to-be-decoded point cloud data is decoded sequentially according to a decoding sequence of the to-be-decoded point; and the processing unit 802 is specifically configured to perform the following steps when performing grouping processing on the to-be-decoded point cloud data:
performing grouping processing on one or more preceding points of a current to-be-decoded point according to a specified rule in a case that the current to-be-decoded point is a repeated point; the preceding point of the current to-be-decoded point being a point whose decoding sequence is before that of the current to-be-decoded point; and that the current to-be-decoded point is a repeated point meaning that geometric information of the current to-be-decoded point is the same as geometric information of any preceding point of the current to-be-decoded point.

In an implementation, each to-be-decoded point in the to-be-decoded point cloud data is decoded sequentially according to a decoding sequence of the to-be-decoded point; and the processing unit 802 is specifically configured to perform the following steps when performing grouping processing on the to-be-decoded point cloud data:
skipping a current to-be-decoded point in a case that the current to-be-decoded point is a repeated point, adding a non-repeated point whose decoding sequence is after that of the current to-be-decoded point to a current point cloud group until a quantity of to-be-decoded points included in the current point cloud group reaches a grouping quantity threshold; that any to-be-decoded point is a non-repeated point meaning that geometric information of the to-be-decoded point is different from geometric information of a preceding point of the to-be-decoded point; that the current to-be-decoded point being a repeated point meaning that geometric information of the current to-be-decoded point is the same as geometric information of any preceding point of the current to-be-decoded point; the preceding point of the to-be-decoded point being a point whose decoding sequence is before that of the to-be-decoded point; and the grouping quantity threshold being a maximum quantity of points that the current point cloud group allows to accommodate.

In an implementation, each to-be-decoded point in the to-be-decoded point cloud data is decoded sequentially according to a decoding sequence of the to-be-decoded point; and the processing unit 802 is specifically configured to perform the following steps when performing grouping processing on the to-be-decoded point cloud data:
adding a current to-be-decoded point to a current point cloud group in a case that the current to-be-decoded point is a repeated point; and adding, in a case that a quantity of points included in the current point cloud group does not reach a grouping quantity threshold, a to-be-decoded point whose decoding sequence is after that of the current to-be-decoded point to the current point cloud group until the quantity of points included in the current point cloud group reaches the grouping quantity threshold; that the current to-be-decoded point being a repeated point meaning that geometric information of the current to-be-decoded point is the same as geometric information of any preceding point of the current to-be-decoded point; the preceding point of the current to-be-decoded point being a point whose decoding sequence is before that of the current to-be-decoded point.

In an implementation, each to-be-decoded point in the to-be-decoded point cloud data is decoded sequentially according to a decoding sequence of the to-be-decoded point; and the processing unit 802 is specifically configured to perform the following steps when performing grouping processing on the to-be-decoded point cloud data:
performing, in a case that a current to-be-decoded point is a repeated point, grouping processing on the repeated point; that the current to-be-decoded point being a repeated point meaning that geometric information of the current to-be-decoded point is the same as geometric information of any preceding point of the current to-be-decoded point; the preceding point of the current to-be-decoded point being a point whose decoding sequence is before that of the current to-be-decoded point.

In an implementation, each to-be-decoded point in the to-be-decoded point cloud data is decoded sequentially according to a decoding sequence of the to-be-decoded point; and the processing unit 802 is specifically configured to perform the following steps when performing the process of performing grouping processing on to-be-decoded point cloud data:
skipping performing grouping processing on a current to-be-decoded point in a case that the current to-be-decoded point is a repeated point, and a quantity of counted repeated points is greater than a first quantity threshold; and performing grouping processing on the current to-be-decoded point in a case that the current to-be-decoded point is a repeated point, but the quantity of counted repeated points is less than or equal to the first quantity threshold.

In an implementation, the target point cloud group is any point cloud group obtained by performing grouping processing on to-be-decoded point cloud data; the attribute decoding mode of the target point cloud group is an inter-group attribute decoding mode; and the processing unit 802 is specifically configured to perform the following steps when performing attribute prediction on each point in the target point cloud group according to the attribute decoding mode of the target point cloud group, to obtain prediction attribute information of each point in the target point cloud group:
determining M associated point cloud groups of the target point cloud group from point cloud groups obtained by performing grouping processing on to-be-decoded point cloud data, the M associated point cloud groups being M neighboring point cloud groups before the target point cloud group in the point cloud groups obtained by performing grouping processing on the to-be-decoded point cloud data and whose decoding sequences are before that of the target point cloud group, and M being a positive integer; determining an average value of reconstruction attribute information of each point in the M associated point cloud groups as the prediction attribute information of each point in the target point cloud group; or determining an associated point of each point in the target point cloud group from the M associated point cloud groups; and determining the prediction attribute information of each point in the target point cloud group according to reconstruction attribute information of the associated point of each point in the target point cloud group.

In an implementation, the attribute decoding mode of the target point cloud group is an intra-group attribute decoding mode; and the processing unit 802 is specifically configured to perform the following steps when performing attribute prediction on each point in the target point cloud group according to the attribute decoding mode of the target point cloud group, to obtain prediction attribute information of each point in the target point cloud group:
separately determining the prediction attribute information of each point in the target point cloud group; or determining prediction attribute information of a target point in the target point cloud group; and determining the prediction attribute information of each point in the target point cloud group according to the prediction attribute information of the target point.

In an implementation, the target point is any one or more points in the target point cloud group; and the processing unit 802 is specifically configured to: perform the following steps when determining the prediction attribute information of each point in the target point cloud group according to the prediction attribute information of the target point:
determining the prediction attribute information of the target point as the prediction attribute information of each point in the target point cloud group in a case that the target point is any point in the target point cloud group; or determining a geometric relationship between another point in the target point cloud group except the target point and the target point in a case that the target point is any point in the target point cloud group; and determining prediction attribute information of the another point according to the geometric relationship between the another point and the target point and the prediction attribute information of the target point; or determining, in a case that the target point is any multiple points in the target point cloud group, an average value of prediction attribute information of the target points as the prediction attribute information of each point in the target point cloud group.

In an implementation, the processing unit 802 is specifically configured to perform the following steps when determining the prediction attribute information of the target point in the target point cloud group: performing grouping processing on the target point cloud group to obtain P point cloud sub-groups, P being an integer greater than or equal to 2; and selecting one point from each point cloud sub-group of the P point cloud sub-groups as the target point, and determining the prediction attribute information of the target point.

The processing unit 802 is specifically configured to: perform the following steps when determining the prediction attribute information of each point in the target point cloud group according to the prediction attribute information of the target point: determining the prediction attribute information of the target point in each point cloud sub-group of the P point cloud sub-groups as prediction attribute information of each point in the corresponding point cloud sub-group.

In an implementation, each point in the target point cloud group is decoded sequentially according to a decoding sequence of the point; the target point cloud group is any point cloud group obtained by performing grouping processing on to-be-decoded point cloud data; and the processing unit 802 is specifically configured to perform the following steps when determining the prediction attribute information of the target point in the target point cloud group:
determining reconstruction attribute information of a neighboring point whose decoding sequence is before that of the target point in the target point cloud group as the prediction attribute information of the target point; or determining Q neighboring points of the target point in a point cloud group obtained by performing grouping processing on to-be-decoded point cloud data, Q being a positive integer; determining a geometric relationship between the Q neighboring points and the target point; and determining a prediction attribute value of the target point according to the geometric relationship between the Q neighboring points and the target point and reconstruction attribute information of the Q neighboring points; the Q neighboring points being Q points that are in the point cloud group obtained by performing grouping processing on the to-be-decoded point cloud data and that are geometrically close to the target point.

In an implementation, the attribute decoding mode includes multiple intra-group attribute decoding modes; and the processing unit 802 is further configured to perform the following steps:
counting a quantity of points included in the target point cloud group; determining that the attribute decoding mode of the target point cloud group is a first intra-group attribute decoding mode in a case that the quantity of points is greater than a second quantity threshold; and determining that the attribute decoding mode of the target point cloud group is a second intra-group attribute decoding mode in a case that the quantity of points is less than or equal to the second quantity threshold, the first intra-group attribute decoding mode being different from the second intra-group attribute decoding mode.

In an implementation, the target point cloud group is any point cloud group obtained by performing grouping processing on to-be-decoded point cloud data; the attribute decoding mode includes an inter-group attribute decoding mode or an intra-group attribute decoding mode; and the obtaining unit 801 is specifically configured to: perform the following steps when obtaining the attribute decoding mode of the target point cloud group:
determining M associated point cloud groups of the target point cloud group from point cloud groups obtained by performing grouping processing on to-be-decoded point cloud data, the M associated point cloud groups being M neighboring point cloud groups before the target point cloud group in the point cloud groups obtained by performing grouping processing on the to-be-decoded point cloud data and whose decoding sequences are before that of the target point cloud group, and M being a positive integer; calculating inter-group similarity between the target point cloud group and the M associated point cloud groups; determining that the attribute decoding mode of the target point cloud group is the inter-group attribute decoding mode in a case that the inter-group similarity is greater than a similarity threshold; and determining that the attribute decoding mode of the target point cloud group is the intra-group attribute decoding mode in a case that the inter-group similarity is less than or equal to the similarity threshold.

According to another embodiment of this disclosure, units of the point cloud decoding apparatus shown in FIG. 8 may be separately or wholly combined into one or several other units, or one (or more) of the units herein may further be divided into multiple units of smaller functions. In this way, the same operations can be implemented, and implementation of the technical effects of the embodiments of this disclosure is not affected. The foregoing units are divided based on logical functions. In an actual application, a function of one unit may be implemented by multiple units, or functions of multiple units are implemented by one unit. In another embodiment of this disclosure, the point cloud decoding apparatus may alternatively include other units. In actual application, these functions may be implemented with the assistance of other units, and may be cooperatively implemented by multiple units.

According to another embodiment of this disclosure, the point cloud decoding apparatus shown in FIG. 8 may be constructed by running a computer program (including program code) capable of performing steps related to the corresponding method shown in FIG. 3 or FIG. 5 on a general-purpose computer device including a processing element such as a central processing unit (CPU), a random access storage medium (RAM), a read-only storage medium (ROM), and a storage element, for example, a computer, to implement the point cloud decoding method in the embodiment of this disclosure. The computer program may be recorded in, for example, a computer-readable storage medium (such as a non-transitory computer-readable storage medium), and may be loaded into the foregoing computing device by using the computer-readable storage medium, and run in the computing device.

In this embodiment of this disclosure, after a to-be-decoded point cloud group and an attribute decoding mode of the point cloud group are obtained, attribute prediction may be performed on each point in the point cloud group according to the attribute decoding mode of the point cloud group, to obtain prediction attribute information of each point in the point cloud group, and attribute decoding processing may be performed on each point in the point cloud group, to obtain reconstruction residual information of each point in the point cloud group, and then reconstruction attribute information of each point in the point cloud group may be determined according to the prediction attribute information and the reconstruction residual information of each point in the point cloud group. It may be understood from the foregoing content that, in this embodiment of this disclosure, attribute prediction is performed by using a group as a unit, and the obtained attribute decoding mode of the point cloud group may be applied to attribute prediction performed on each point in the point cloud group. In this way, prediction efficiency of the point cloud attribute can be improved, and further, decoding efficiency of the point cloud attribute can be improved. In addition, in this embodiment of this disclosure, attribute decoding processing is finally performed on each point in the point cloud group to obtain reconstruction residual information of each point in the point cloud group instead of reconstruction attribute information. In this way, an amount of data decoded during attribute decoding processing can be reduced, and decoding efficiency of the point cloud attribute is further improved.

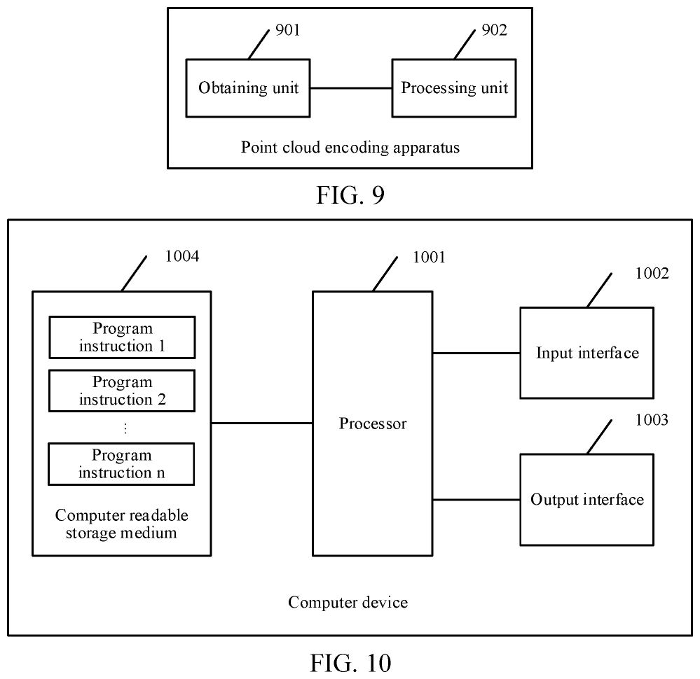

Referring to FIG. 9, FIG. 9 is a schematic structural diagram of a point cloud encoding apparatus according to an embodiment of this disclosure. The point cloud encoding apparatus may be disposed in a computer device provided in this embodiment of this disclosure, and the computer device may be the encoding device mentioned in the foregoing method embodiment. In some embodiments, the point cloud encoding apparatus may be a computer program (including program code) running in a computer device, and the point cloud encoding apparatus may be configured to perform corresponding steps in the method embodiment shown in FIG. 7. Referring to FIG. 8, the point cloud encoding apparatus may include an obtaining unit 901 and a processing unit 902.

The obtaining unit 901 is configured to obtain a to-be-encoded target point cloud group and an attribute encoding mode of the target point cloud group, the target point cloud group including at least one to-be-encoded point.

The processing unit 902 is configured to perform attribute prediction on each point in the target point cloud group according to the attribute encoding mode of the target point cloud group, to obtain prediction attribute information of each point in the target point cloud group; determine prediction residual information of each point in the target point cloud group according to the prediction attribute information and real attribute information of each point in the target point cloud group; and perform attribute encoding processing on each point in the target point cloud group based on the prediction residual information of each point in the target point cloud group, to obtain an encoded target point cloud group.

In an implementation, the processing unit 902 is specifically configured to perform the following steps when performing attribute encoding processing on each point in the target point cloud group based on the prediction residual information of each point in the target point cloud group, to obtain an encoded target point cloud group:
performing attribute encoding processing on the prediction residual information of each point in the target point cloud group to obtain the encoded target point cloud group; or performing transform processing on the prediction residual information of each point in the target point cloud group, to obtain a residual transform coefficient of each point in the target point cloud group; and performing attribute encoding processing on the residual transform coefficient of each point in the target point cloud group, to obtain the encoded target point cloud group.

In an implementation, the processing unit 902 is further configured to perform the following steps:
performing transform determining on the target point cloud group; and triggering the operation of performing transform processing on the prediction residual information of each point in the target point cloud group to obtain a residual transform coefficient of each point in the target point cloud group in a case that the target point cloud group meets a transform condition; that the target point cloud group meets the transform condition including any one of the following: a quantity of points included in the target point cloud group meets a quantity condition, or distribution of the prediction residual information of each point in the target point cloud group meets a distribution condition.

In an implementation, the target point cloud group is any point cloud group obtained by performing grouping processing on to-be-encoded point cloud data; performing grouping processing on the to-be-encoded point cloud data further obtains a first point cloud group, the first point cloud group being any point cloud group other than the target point cloud group; an attribute encoding mode of the first point cloud group is different from the attribute encoding mode of the target point cloud group; or an attribute encoding mode of the first point cloud group is the same as the attribute encoding mode of the target point cloud group.

In an implementation, each to-be-encoded point in the to-be-encoded point cloud data is sequentially encoded according to an encoding sequence of the to-be-encoded point; and the processing unit 902 is specifically configured to perform the following steps when performing grouping processing on the to-be-encoded point cloud data:
performing grouping processing on one or more preceding points of a current to-be-encoded point according to a specified rule in a case that the current to-be-encoded point is a repeated point; the preceding point of the current to-be-encoded point being a point whose encoding sequence is before that of the current to-be-encoded point; and that the current to-be-encoded point is a repeated point meaning that geometric information of the current to-be-encoded point is the same as geometric information of any preceding point of the current to-be-encoded point.

In an implementation, each to-be-encoded point in the to-be-encoded point cloud data is sequentially encoded according to an encoding sequence of the to-be-encoded point; and the processing unit 902 is specifically configured to perform the following steps when performing grouping processing on the to-be-encoded point cloud data:
skipping a current to-be-encoded point in a case that the current to-be-encoded point is a repeated point, adding a non-repeated point whose encoding sequence is after that of the current to-be-encoded point to a current point cloud group until a quantity of to-be-encoded points included in the current point cloud group reaches a grouping quantity threshold; that any to-be-encoded point is a non-repeated point meaning that geometric information of the to-be-encoded point is different from geometric information of a preceding point of the to-be-encoded point; that the current to-be-encoded point is a repeated point meaning that geometric information of the current to-be-encoded point is the same as geometric information of any preceding point of the current to-be-encoded point. the preceding point of the to-be-encoded point being a point whose encoding sequence is before that of the to-be-encoded point; and the grouping quantity threshold being a maximum quantity of points that the current point cloud group allows to accommodate.

In an implementation, each to-be-encoded point in the to-be-encoded point cloud data is sequentially encoded according to an encoding sequence of the to-be-encoded point; and the processing unit 902 is specifically configured to perform the following steps when performing grouping processing on the to-be-encoded point cloud data:
adding a current to-be-encoded point to a current point cloud group in a case that the current to-be-encoded point is a repeated point; and adding, in a case that a quantity of points included in the current point cloud group does not reach a grouping quantity threshold, a to-be-encoded point whose encoding sequence is after that of the current to-be-encoded point to the current point cloud group until the quantity of points included in the current point cloud group reaches the grouping quantity threshold; that the current to-be-encoded point is a repeated point meaning that geometric information of the current to-be-encoded point is the same as geometric information of any preceding point of the current to-be-encoded point; and the preceding point of the current to-be-encoded point being a point whose encoding sequence is before that of the current to-be-encoded point.

In an implementation, each to-be-encoded point in the to-be-encoded point cloud data is sequentially encoded according to an encoding sequence of the to-be-encoded point; and the processing unit 902 is specifically configured to perform the following steps when performing grouping processing on the to-be-encoded point cloud data:
performing, in a case that a current to-be-encoded point is a repeated point, grouping processing on the repeated point; that the current to-be-encoded point is a repeated point meaning that geometric information of the current to-be-encoded point is the same as geometric information of any preceding point of the current to-be-encoded point; and the preceding point of the current to-be-encoded point being a point whose encoding sequence is before that of the current to-be-encoded point.

In an implementation, each to-be-encoded point in the to-be-encoded point cloud data is sequentially encoded according to an encoding sequence of the to-be-encoded point; and the processing unit 902 is specifically configured to perform the following steps when performing grouping processing on the to-be-encoded point cloud data:
skipping performing grouping processing on a current to-be-encoded point in a case that the current to-be-encoded point is a repeated point, and a quantity of counted repeated points is greater than a first quantity threshold; and performing grouping processing on the current to-be-encoded point in a case that the current to-be-encoded point is a repeated point, but the quantity of counted repeated points is less than or equal to the first quantity threshold.

In an implementation, the target point cloud group is any point cloud group obtained by performing grouping processing on to-be-encoded point cloud data; the attribute encoding mode of the target point cloud group is an inter-group attribute encoding mode; and the processing unit 902 is specifically configured to perform the following steps when performing attribute prediction on each point in the target point cloud group according to the attribute encoding mode of the target point cloud group, to obtain prediction attribute information of each point in the target point cloud group:
determining M associated point cloud groups of the target point cloud group from point cloud groups obtained by performing grouping processing on to-be-encoded point cloud data, the M associated point cloud groups being M neighboring point cloud groups before the target point cloud group in the point cloud groups obtained by performing grouping processing on the to-be-encoded point cloud data and whose encoding sequences are before that of the target point cloud group, and M being a positive integer; determining an average value of reconstruction attribute information of each point in the M associated point cloud groups as the prediction attribute information of each point in the target point cloud group; or determining an associated point of each point in the target point cloud group from the M associated point cloud groups; and determining the prediction attribute information of each point in the target point cloud group according to reconstruction attribute information of the associated point of each point in the target point cloud group.

In an implementation, the attribute encoding mode of the target point cloud group is an intra-group attribute encoding mode; and the processing unit 902 is specifically configured to perform the following steps when performing attribute prediction on each point in the target point cloud group according to the attribute encoding mode of the target point cloud group, to obtain prediction attribute information of each point in the target point cloud group:
separately determining the prediction attribute information of each point in the target point cloud group; or determining prediction attribute information of a target point in the target point cloud group; and determining the prediction attribute information of each point in the target point cloud group according to the prediction attribute information of the target point.

In an implementation, the target point is any one or more points in the target point cloud group; and the processing unit 902 is specifically configured to: perform the following steps when determining the prediction attribute information of each point in the target point cloud group according to the prediction attribute information of the target point:
determining the prediction attribute information of the target point as the prediction attribute information of each point in the target point cloud group in a case that the target point is any point in the target point cloud group; or determining a geometric relationship between another point in the target point cloud group except the target point and the target point in a case that the target point is any point in the target point cloud group; and determining prediction attribute information of the another point according to the geometric relationship between the another point and the target point and the prediction attribute information of the target point; or determining, in a case that the target point is any multiple points in the target point cloud group, an average value of prediction attribute information of the target points as the prediction attribute information of each point in the target point cloud group.

In an implementation, the processing unit 902 is specifically configured to perform the following steps when determining the prediction attribute information of the target point in the target point cloud group: performing grouping processing on the target point cloud group to obtain P point cloud sub-groups, P being an integer greater than or equal to 2; and selecting one point from each point cloud sub-group of the P point cloud sub-groups as the target point, and determining the prediction attribute information of the target point.

The processing unit 902 is specifically configured to: perform the following steps when determining the prediction attribute information of each point in the target point cloud group according to the prediction attribute information of the target point: determining the prediction attribute information of the target point in each point cloud sub-group of the P point cloud sub-groups as prediction attribute information of each point in the corresponding point cloud sub-group.

In an implementation, each point in the target point cloud group is sequentially encoded according to an encoding sequence of the point; the target point cloud group is any point cloud group obtained by performing grouping processing on to-be-encoded point cloud data; and the processing unit 902 is specifically configured to perform the following steps when determining the prediction attribute information of the target point in the target point cloud group:
determining reconstruction attribute information of a neighboring point whose encoding sequence is before that of the target point in the target point cloud group as the prediction attribute information of the target point; or determining Q neighboring points of the target point in a point cloud group obtained by performing grouping processing on to-be-encoded point cloud data, Q being a positive integer; determining a geometric relationship between the Q neighboring points and the target point; and determining a prediction attribute value of the target point according to the geometric relationship between the Q neighboring points and the target point and reconstruction attribute information of the Q neighboring points; the Q neighboring points being Q points that are in the point cloud group obtained by performing grouping processing on the to-be-encoded point cloud data and that are geometrically close to the target point.

In one implementation, the attribute encoding mode includes multiple intra-group attribute encoding modes; and the processing unit 902 is further configured to perform the following steps:
counting a quantity of points included in the target point cloud group; determining that the attribute encoding mode of the target point cloud group is a first intra-group attribute encoding mode in a case that the quantity of points is greater than a second quantity threshold; and determining that the attribute encoding mode of the target point cloud group is a second intra-group attribute encoding mode in a case that the quantity of points is less than or equal to the second quantity threshold, the first intra-group attribute encoding mode being different from the second intra-group attribute encoding mode.

In an implementation, the target point cloud group is any point cloud group obtained by performing grouping processing on to-be-encoded point cloud data; the attribute encoding mode includes an inter-group attribute encoding mode or an intra-group attribute encoding mode; and the obtaining unit 901 is specifically configured to: perform the following steps when obtaining the attribute encoding mode of the target point cloud group:
determining M associated point cloud groups of the target point cloud group from point cloud groups obtained by performing grouping processing on to-be-encoded point cloud data, the M associated point cloud groups being M neighboring point cloud groups before the target point cloud group in the point cloud groups obtained by performing grouping processing on the to-be-encoded point cloud data and whose encoding sequences are before that of the target point cloud group, and M being a positive integer; calculating inter-group similarity between the target point cloud group and the M associated point cloud groups; determining that the attribute encoding mode of the target point cloud group is the inter-group attribute encoding mode in a case that the inter-group similarity is greater than a similarity threshold; and determining that the attribute encoding mode of the target point cloud group is the intra-group attribute encoding mode in a case that the inter-group similarity is less than or equal to the similarity threshold.

In an implementation, the attribute encoding mode includes an inter-group attribute encoding mode or an intra-group attribute encoding mode; and the obtaining unit 901 is specifically configured to: perform the following steps when obtaining the attribute encoding mode of the target point cloud group:
performing attribute prediction on each point in the target point cloud group according to the inter-group attribute encoding mode, to obtain prediction attribute information of each point in the target point cloud group in the inter-group attribute encoding mode; performing encoding processing on the prediction attribute information of each point in the target point cloud group in the inter-group attribute encoding mode to obtain first encoding information; performing attribute prediction on each point in the target point cloud group according to the intra-group attribute encoding mode, to obtain prediction attribute information of each point in the target point cloud group in the intra-group attribute encoding mode; performing encoding processing on the prediction attribute information of each point in the target point cloud group in the intra-group attribute encoding mode to obtain second encoding information; determining that the attribute encoding mode of the target point cloud group is the intra-group attribute encoding mode in a case that the first encoding information is greater than or equal to the second encoding information; and determining that the attribute encoding mode of the target point cloud group is the inter-group attribute encoding mode in a case that the first encoding information is less than the second encoding information.

According to another embodiment of this disclosure, units of the point cloud encoding apparatus shown in FIG. 9 may be separately or wholly combined into one or several other units, or one (or more) of the units herein may further be divided into multiple units of smaller functions. In this way, the same operations can be implemented, and implementation of the technical effects of the embodiments of this disclosure is not affected. The foregoing units are divided based on logical functions. In an actual application, a function of one unit may be implemented by multiple units, or functions of multiple units are implemented by one unit. In another embodiment of this disclosure, the point cloud encoding apparatus may alternatively include other units. In actual application, these functions may be implemented with the assistance of other units, and may be cooperatively implemented by multiple units.

According to another embodiment of this disclosure, the point cloud encoding apparatus shown in FIG. 9 may be constructed by running a computer program (including program code) capable of performing steps related to the corresponding method shown in FIG. 7 on a general-purpose computer device including a processing element such as a central processing unit (CPU), a random access storage medium (RAM), a read-only storage medium (ROM), and a storage element, for example, a computer, to implement the point cloud encoding method in the embodiment of this disclosure. The computer program may be recorded in, for example, a computer-readable storage medium, and may be loaded into the foregoing computing device by using the computer-readable storage medium, and run in the computing device.

In this embodiment of this disclosure, after a to-be-encoded point cloud group and an attribute encoding mode of the point cloud group are obtained, attribute prediction may be performed on each point in the point cloud group according to the attribute encoding mode of the point cloud group, to obtain prediction attribute information of each point in the point cloud group, where the prediction attribute information of each point in the point cloud group may be used for determining prediction residual information of each point in the point cloud group, and encoding processing is performed on each point in the point cloud group based on the prediction residual information of each point in the point cloud group, to obtain an encoded point cloud group. It may be understood from the foregoing content that, in this embodiment of this disclosure, attribute prediction is performed by using a group as a unit, and the obtained attribute encoding mode of the point cloud group may be applied to attribute prediction performed on each point in the point cloud group. In this way, prediction efficiency of the point cloud attribute can be improved, and further, encoding efficiency of the point cloud attribute can be improved. In addition, in this embodiment of this disclosure, attribute encoding processing may be performed on each point in the point cloud group based on the prediction residual information of each point in the point cloud group, without performing attribute encoding processing on real attribute information of each point in the point cloud group. In this way, an amount of data encoded during attribute encoding processing can be reduced, and encoding efficiency of the point cloud attribute can be further improved.

Based on the foregoing method and apparatus embodiments, an embodiment of this disclosure provides a computer device. The computer device may be the foregoing decoding device or encoding device. Referring to FIG. 10, FIG. 10 is a schematic structural diagram of a computer device according to an embodiment of this disclosure. The computer device shown in FIG. 10 includes at least a processor 1001, an input interface 1002, an output interface 1003, and a computer-readable storage medium 1004. The processor 1001, the input interface 1002, the output interface 1003, and the computer-readable storage medium 1004 may be connected by using a bus or in another manner.

The input interface 1002 may be configured to obtain a to-be-decoded target point cloud group, obtain an attribute decoding mode of the target point cloud group, obtain a to-be-encoded target point cloud group, obtain an attribute encoding mode of the target point cloud group, and the like. The output interface 1003 may be configured to output an encoded target point cloud group or a decoded target point cloud group.

The computer-readable storage medium 1004 may be stored in a memory of the computer device. The computer-readable storage medium 1004 is configured to store a computer program. The computer program includes computer instructions. The processor 1001 is configured to execute the program instructions stored in the computer-readable storage medium 1004. The processor 1001 (or referred to as a central processing unit (CPU)) is a computing core and a control core of the computer device, and is adapted to implement one or more computer instructions, and is specifically adapted to load and execute one or more computer instructions, so as to implement a corresponding method procedure or a corresponding function.

An embodiment of this disclosure further provides a computer-readable storage medium (Memory), such as a non-transitory computer-readable storage medium. The computer-readable storage medium is a memory device in a computer device, and is configured to store a program and data. It may be understood that the computer-readable storage medium herein may include a built-in storage medium in the computer device, and certainly may also include an extended storage medium supported by the computer device. The computer-readable storage medium provides storage space, and the storage space stores an operating system of the computer device. In addition, one or more computer instructions suitable for being loaded and executed by a processor are further stored in the storage space. These computer instructions may be one or more computer programs (including program code). The computer-readable storage medium herein may be a high-speed RAM memory, or may be a non-volatile memory, for example, at least one disk memory. The computer-readable storage medium may be at least one computer-readable storage medium located far away from the foregoing processor.

In an embodiment, the one or more computer instructions stored in the computer-readable storage medium 1004 may be loaded and executed by the processor 1001, so as to implement the foregoing corresponding steps of the point cloud decoding method shown in FIG. 3 or FIG. 5.

An aspect of this disclosure provides a computer program product or a computer program, the computer program product or the computer program including computer instructions, the computer instructions being stored in a computer-readable storage medium. A processor of a computer device reads the computer instructions from the computer-readable storage medium, and the processor executes the computer instructions, so that the computer device executes the point cloud decoding method or the point cloud encoding method provided in the foregoing exemplary manners.

The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, such as at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely exemplary implementations of this disclosure, and are not intended to limit the scope of this disclosure. Variations or replacements shall fall within the scope of this disclosure.

What is claimed is:

1. A point cloud decoding method, comprising:
obtaining a target point cloud group of a plurality of point cloud groups, the target point cloud group including at least one point;
determining an attribute coding mode of the target point cloud group;
obtaining prediction attribute information of each point in the target point cloud group based on attribute prediction of the respective point in the target point cloud group according to the attribute coding mode of the target point cloud group;
obtaining reconstruction residual information of each point in the target point cloud group based on attribute decoding of the respective point in the target point cloud group; and
determining reconstruction attribute information of each point in the target point cloud group according to the prediction attribute information and the reconstruction residual information of the respective point in the target point cloud group.

2. The method according to claim 1, wherein the obtaining the reconstruction residual information comprises:
performing the attribute decoding on each point in the target point cloud group to obtain a reconstruction transform coefficient of the respective point in the target point cloud group, and performing inverse transform processing on the reconstruction transform coefficient of the respective point in the target point cloud group to obtain the reconstruction residual information of the respective point in the target point cloud group.

3. The method according to claim 2, further comprising:
triggering, when the target point cloud group meets a transform condition, the performing of the inverse transform processing on the reconstruction transform coefficient of each point in the target point cloud group to obtain the reconstruction residual information of the respective point in the target point cloud group,
wherein the transform condition includes a quantity of points included in the target point cloud group meets a quantity condition or distribution of the reconstruction residual information of each point in the target point cloud group meets a distribution condition.

4. The method according to claim 1, further comprising:
grouping at least one point of point cloud data into a first point cloud group of the plurality of point cloud groups, the first point cloud group being different from the target point cloud group.

5. The method according to claim 4, wherein each point in the point cloud data is decoded sequentially according to a decoding sequence, and the grouping comprises:
grouping at least one preceding point of a current point according to a specified rule when the current point is a repeated point, wherein
the preceding point of the current point is decoded before the current point in the decoding sequence, and
geometric information of the current point is the same as geometric information of the preceding point of the current point when the current point is the repeated point.

6. The method according to claim 4, wherein each point in the point cloud data is decoded sequentially according to a decoding sequence, and the grouping comprises:
skipping a current point when the current point is a repeated point, adding a non-repeated point that is decoded after the current point in the decoding sequence to a current point cloud group until a quantity of points included in the current point cloud group reaches a grouping quantity threshold, wherein
geometric information of the non-repeated point is different from geometric information of a preceding point of the non-repeated point,
geometric information of the current point is the same as geometric information of the preceding point of the current point when the current point is the repeated point,
the preceding point is decoded before the current point in the decoding sequence, and
the grouping quantity threshold is a maximum quantity of points to be included in the current point cloud group.

7. The method according to claim 4, wherein each point in the point cloud data is decoded sequentially according to a decoding sequence, and the grouping comprises:
adding a current point to a current point cloud group when the current point is a repeated point; and
adding, when a quantity of points included in the current point cloud group does not reach a grouping quantity threshold, at least one point that is decoded after the current point in the decoding sequence to the current point cloud group until the quantity of points included in the current point cloud group reaches the grouping quantity threshold, wherein
geometric information of the current point is the same as geometric information of a preceding point of the current point when the current point is the repeated point, and
the preceding point of the current point is decoded before the current point in the decoding sequence.

8. The method according to claim 4, wherein each point in the point cloud data is decoded sequentially according to a decoding sequence, and the grouping comprises:
grouping, when a current point is a repeated point, the repeated point, wherein
geometric information of the current point is the same as geometric information of a preceding point of the current point, and
the preceding point of the current point is decoded before the current point in the decoding sequence.

9. The method according to claim 4, wherein each point in the point cloud data is decoded sequentially according to a decoding sequence, and the grouping comprises:
skipping a current point when the current point is a repeated point, and a quantity of counted repeated points is greater than a first quantity threshold; and
grouping the current point when the current point is the repeated point, but the quantity of counted repeated points is less than or equal to the first quantity threshold.

10. The method according to claim 1, wherein
the attribute coding mode of the target point cloud group is an inter-group attribute decoding mode; and
the obtaining the prediction attribute information of each point in the target point cloud group comprises:
determining M associated point cloud groups of the target point cloud group from point cloud groups of point cloud data, the M associated point cloud groups being M neighboring point cloud groups before the target point cloud group in the point cloud groups that are decoded before the target point cloud group in a decoding sequence, and M being a positive integer;
determining an average value of reconstruction attribute information of each point in the M associated point cloud groups as the prediction attribute information of each point in the target point cloud group; or
determining an associated point of each point in the target point cloud group from the M associated point cloud groups, and determining the prediction attribute information of each point in the target point cloud group according to reconstruction attribute information of the associated point of each point in the target point cloud group.

11. The method according to claim 1, wherein
the attribute coding mode of the target point cloud group is an intra-group attribute decoding mode; and
the obtaining the prediction attribute information comprises:
separately determining the prediction attribute information of each point in the target point cloud group; or
determining the prediction attribute information of a target point in the target point cloud group, and determining the prediction attribute information of each point in the target point cloud group according to the prediction attribute information of the target point.

12. The method according to claim 11, wherein the obtaining the prediction attribute information comprises:
determining the prediction attribute information of the target point as the prediction attribute information of each point in the target point cloud group when the target point is one point in the target point cloud group; or
determining a geometric relationship between another point in the target point cloud group that is different from the target point and the target point when the target point is one point in the target point cloud group, and determining the prediction attribute information of the another point according to the geometric relationship between the another point and the target point and the prediction attribute information of the target point; or
determining, when the target point is one of multiple target points in the target point cloud group, an average value of the prediction attribute information of the target points as the prediction attribute information of each point in the target point cloud group.

13. The method according to claim 11, wherein the determining the prediction attribute information of the target point in the target point cloud group comprises:
grouping the points of the target point cloud group to obtain P point cloud sub-groups, P being an integer greater than or equal to 2, and selecting one point from each point cloud sub-group of the P point cloud sub-groups as the target point, and determining the prediction attribute information of the target point; and
the determining the prediction attribute information of each point in the target point cloud group according to the prediction attribute information of the target point comprises:
determining the prediction attribute information of the target point in each point cloud sub-group of the P point cloud sub-groups as the prediction attribute information of each point in the corresponding point cloud sub-group.

14. The method according to claim 11, wherein
each point in the target point cloud group is decoded sequentially according to a decoding sequence; and
the determining the prediction attribute information of the target point in the target point cloud group comprises:
determining reconstruction attribute information of a neighboring point that is decoded before the target point in the target point cloud group in the decoding sequence as the prediction attribute information of the target point; or
determining Q neighboring points of the target point in a point cloud group obtained by grouping points in point cloud data, Q being a positive integer, determining a geometric relationship between the Q neighboring points and the target point, and determining a prediction attribute value of the target point according to the geometric relationship between the Q neighboring points and the target point and the reconstruction attribute information of the Q neighboring points, the Q neighboring points being Q points that are in the point cloud group that are geometrically close to the target point.

15. The method according to claim 1, wherein
the attribute decoding mode includes multiple intra-group attribute decoding modes; and
the method further comprises:
counting a quantity of points included in the target point cloud group;
determining that the attribute coding mode of the target point cloud group is a first intra-group attribute coding mode based on the quantity of points being greater than a second quantity threshold; and
determining that the attribute coding mode of the target point cloud group is a second intra-group attribute coding mode based on the quantity of points being less than or equal to the second quantity threshold, the first intra-group attribute decoding mode being different from the second intra-group attribute decoding mode.

16. The method according to claim 1, wherein
the attribute coding mode includes an inter-group attribute decoding mode or an intra-group attribute decoding mode; and
the determining the attribute coding mode of the target point cloud group comprises:
determining M associated point cloud groups of the target point cloud group from point cloud groups obtained by grouping point cloud data, the M associated point cloud groups being M neighboring point cloud groups grouped before the target point cloud group in the point cloud groups before that of the target point cloud group in a decoding sequence, and M being a positive integer;
calculating inter-group similarity between the target point cloud group and the M associated point cloud groups;
determining that the attribute coding mode of the target point cloud group is the inter-group attribute decoding mode based on the inter-group similarity being greater than a similarity threshold; and
determining that the attribute coding mode of the target point cloud group is the intra-group attribute decoding mode based on the inter-group similarity being less than or equal to the similarity threshold.

17. A point cloud encoding method, comprising:
obtaining a target point cloud group of a plurality of point cloud groups, the target point cloud group include at least one point;
determining an attribute coding mode of the target point cloud group;
obtaining prediction attribute information of each point in the target point cloud group based on attribute prediction of the respective point in the target point cloud group according to the attribute coding mode of the target point cloud group;
determining prediction residual information of each point in the target point cloud group according to the prediction attribute information and real attribute information of the respective point in the target point cloud group; and
performing attribute encoding on each point in the target point cloud group based on the prediction residual information of the respective point in the target point cloud group, to obtain an encoded target point cloud group.

18. A point cloud decoding apparatus, comprising:
processing circuitry configured to:
obtain a target point cloud group of a plurality of point cloud groups, the target point cloud group including at least one point,
determine an attribute coding mode of the target point cloud group,
obtain prediction attribute information of each point in the target point cloud group based on attribute prediction of the respective point in the target point cloud group according to the attribute coding mode of the target point cloud group,
obtain reconstruction residual information of each point in the target point cloud group based on attribute decoding of the respective point in the target point cloud group, and
determine reconstruction attribute information of each point in the target point cloud group according to the prediction attribute information and the reconstruction residual information of the respective point in the target point cloud group.

19. The point cloud decoding apparatus according to claim 18, wherein the processing circuitry is configured to:
perform the attribute decoding on each point in the target point cloud group to obtain a reconstruction transform coefficient of the respective point in the target point cloud group, and perform inverse transform processing on the reconstruction transform coefficient of the respective point in the target point cloud group to obtain the reconstruction residual information of the respective point in the target point cloud group.

20. The point cloud decoding apparatus according to claim 19, wherein the processing circuitry is configured to:
trigger, when the target point cloud group meets a transform condition, the performing of the inverse transform processing on the reconstruction transform coefficient of each point in the target point cloud group to obtain the reconstruction residual information of the respective point in the target point cloud group,
wherein the transform condition includes a quantity of points included in the target point cloud group meets a quantity condition or distribution of the reconstruction residual information of each point in the target point cloud group meets a distribution condition.
